(19) United States
(12) Patent Application Publication
(10) Pub. No.: US 2013/0288150 A1
(43) Pub. Date: Oct. 31, 2013

(54) FUEL CELL AND ELECTROLYSER STRUCTURE

(71) Applicants: Alastair M. Hodges, Melbourne (AU); Garry Chambers, Melbourne (AU)

(72) Inventors: Alastair M. Hodges, Melbourne (AU); Garry Chambers, Melbourne (AU)

(73) Assignee: GARAL PTY LTD, Melbourne (AU)

(21) Appl. No.: 13/997,622

(22) PCT Filed: Dec. 23, 2011
(86) PCT No.: PCT/IB11/55924

§ 371 Date: Jun. 24, 2013

Related U.S. Application Data
(60) Provisional application No. 61/427,100, filed on Dec. 23, 2010.

(51) Int. Cl. H01M 8/00; C25B 9/18; H01M 8/24; C25B 9/06

(52) U.S. Cl. CPC H01M 8/004; C25B 9/06; C25B 9/18; H01M 8/249
USPC 429/466; 204/272; 204/267; 205/334; 205/347; 429/497; 429/487; 429/535; 29/825

(57) ABSTRACT

Disclosed herein are fuel cell elements including at least one electronically conductive layer and an ion conductive layer. The fuel cell elements can have a tubular cross-section or an enclosed cross-section of another shape. Also disclosed is an assembly of fuel cell elements to form cell tubes and stacks of such fuel cell elements or cell tubes. Fuel cell elements, or cell tubes, or stacks thereof can also be used as an electrolyser. Further disclosed are methods of making such fuel cell elements, cell tubes and stacks thereof, as well as methods of using the same.

### BACKGROUND

Fuel cells can provide a more efficient method for converting chemical energy into electrical energy than combustion. Additionally, hydrogen fuel cells can also offer a cleaner alternative with less impact on global warming as the waste product is water rather than carbon dioxide and/or other hazardous combustion products. Hydrogen as a fuel is also amenable to efficient generation by alternative energy technologies and provides a useful and potentially mobile energy storage medium. For these reasons there is great interest in producing low cost hydrogen fuel cells with high performance and/or efficiency. These can be for stationary applications such as remote electricity generation or back-up energy generation; alternatively, or in addition, these can be for mobile applications such as replacing combustion engines in cars and trucks.

As well as low cost and efficient fuel-cells, low cost and efficient water electrolysers are sought after so that electricity generated by intermittent sources, such as renewable sources, can be stored as hydrogen and oxygen for later use, for example, in fuel cells, to generate electricity on demand.

### SUMMARY

Embodiments of the invention disclosed herein are directed to designs of tubular cell elements, cell tubes and stacks thereof. The tubular cell elements can include tubular fuel cell elements of tubular electrolyser cell elements. Embodiments of the invention are primarily described with reference to a PEM type fuel cell. This is for illustration purposes only and is not intended to limit the scope of the disclosure. The embodiments disclosed herein are equally applicable to other types of fuel cells or electrolyser cells such as solid oxide fuel cells (SOFC).

Some embodiments of the invention include a tubular cell element comprising an inner electronically conductive layer, an outer electronically conductive layer, an electronically insulating layer, and an ion conductive layer. The tubular cell element can further include at least one of an inner current collector layer and an outer current collector layer. The tubular cell element can be a tubular fuel cell or an electrolyser cell. At least one of the inner electronically conductive layer, the outer electronically conductive layer, an ion conductive layer, the inner current collector layer and the outer current collector layer can include a sheet of material helically wound to form a tube structure. At least one of the inner electronically conductive layers and the outer electronically conductive layer can include an incomplete layer of solid non-porous material, wherein the incomplete layer can include a wire. At least one of the inner electronically conductive layer and the outer electronically conductive layer can include a porous material. The porous material can be macroporous, or it can be microporous. At least one of the inner electronically conductive layer, the outer electronically conductive layer, the inner current collector layer and the outer current collector layer can include at least one material selected from, but not limited to, carbon, stainless steel, titanium, nickel, copper, tin, and other metals, or alloys thereof.

Merely by way of example, at least one of the inner electronically conductive layer and the outer electrically conductive layer can include woven carbon filament material. The ion conductive layer can include an electronically insulating layer. The electronically insulating layer can include a porous material. The electronically insulating layer can prevent a first agent and a second agent on different sides of the electronically insulating layers from excessively mixing with each other. At least one of the first agent and the second agent can include a liquid, a vapour, or a gas. The first agent or the second agent can include a liquid such as methanol, or a gas, or a vapour selected from, for example, hydrogen, oxygen, methanol vapour, and air. The ion conductive layer can include an inorganic ion exchange material or an organic polymeric ion exchange material.

Merely by way of example, the ion conductive layer can include, for example, a silicate material, an aluminosilicate, a metal oxide, a ceramic material, a macroporous polymer, an ion exchange polymer, and the like. For example, the ion conductive layer can include a zeolite or Nafion®. The ion conductive layer can include an ion exchange material deposited in the pores of the electronically insulating layer. The electronically insulating layer can include a porous ceramic layer or a porous clay layer. The ion conductive layer can be formed by winding a sheet of ion conductive material around a tube structure comprising the inner electronically conductive layer, wherein the adjacent winds of the ion conductive sheet can be placed so as to at least partially overlap one another to form an overlap region. The tubular cell element can include a catalyst. The catalyst can be deposited on at least one of the conductive layer, the inner electronically conductive layer, and the outer electronically conductive layer. The catalyst can be in contact with the ion conductive layer.

Merely by way of example, the catalyst can include platinum and/or ruthenium. The inner current collector layer can include at least one first protrusion, wherein the at least one first protrusion can penetrate into the inner electronically conductive layer. The outer current collector layer can include at least one second protrusion, wherein the at least one second protrusion can penetrate into the outer electronically conductive layer.

Some embodiments of the invention disclosed herein include a cell tube including a multiplicity of tubular cell elements as described herein. The tubular cell elements can be assembled end to end in electrical connection. The assembly of the multiplicity of tubular cell elements can form a tubular structure with a shell side and a bore side, wherein a first agent in the shell side of the cell tube can be substantially prevented from mixing with a second agent on the bore side of the cell tube. At least one of the first agent and the second agent can include a liquid, a vapour, or a gas. The first agent or the second agent can include a liquid such as methanol, or a gas or a vapour selected from, for example, hydrogen, methanol vapour, oxygen and air. The electrical connection can include at least one connection selected from an in-serial connection and an in-parallel connection, or a combination thereof. The electrical connection can include at least one in-serial connection, wherein the anode of one tubular cell element can be connected to the cathode of an adjacent tubular cell element. The electrical connection can include an electrically conductive connecting piece. The cell tube further can include at least one electronically insulating sealing piece, wherein the at least one electronically insulating sealing piece can include at least two faces, wherein one face can form a seal with the electrically conductive connecting piece, wherein the other face can form a seal with the ion conductive layer of the tubular cell element.

Some embodiments of the invention include a stack including a plurality of the cell tubes as disclosed herein. The ends of the plurality of the cell tubes can be sealed into at least a first sealing plate. The first sealing plate can divide the stack into at least a first section and a second section. The shell side of the cell tubes can be open to the first section, and the bore side of the cell tubes can be open to the second section. The cell tubes can be placed substantially parallel to one another. The stack can further include one or more cooling tubes. The ends of the one or more cooling tubes can be sealed into at least a second sealing plate, wherein the first sealing plate and the second sealing plate can divide the stack into the first section, the second section, and a third section, wherein the bore side of the cooling tubes can be open to the third section. The stack can include more than one cooling tube, wherein the cooling tubes can be placed substantially parallel to one another. In some embodiments, at least a portion of the wall of the one or more cooling tubes allows a cooling medium to exit from the bore side of the one or more cooling tubes to wet the outside of the one or more cooling tubes. The cooling medium can include liquid water. The plurality of the cell tubes can include one or more tubular fuel cell elements. The plurality of the cell tubes can include one or more tubular electrolyser cell elements. At least one of the bore side of the cell tubes and the shell side of the cell tubes, or both, can be flooded with liquid water, e.g., when the stack includes multiple electrolyser cell elements and is used as an electrolyser. In some embodiments, the stack includes a plurality of tubular cell elements (e.g., tubular fuel cell elements or tubular electrolyser elements), wherein the tubular cell elements are not pre-assembled to cell tubes before packed into the stack. In some embodiments, the bore side of the tubular cell element corresponds to the bore side of the cell tubes in the embodiments described elsewhere when the stack including cell tubes, while the shell side of the tubular cell elements corresponds to the shell side of the cell tubes.

Some embodiments of the invention include a method of manufacturing a tubular cell element described herein. The method can include forming a tube structure using a first electronically conductive material to form an inner electronically conductive layer, winding a sheet of ion conductive material around the tube structure comprising the inner electronically conductive layer; and wrapping a second electronically conductive material to form an outer electronically conductive layer. Adjacent winds of the ion conductive sheet can be placed so as to at least partially overlap one another to form an overlap region, wherein the method can include adding heat sealing or adhesive sealing to the overlap region.

Some embodiments of the invention include a method of manufacturing a cell tube described herein.

Some embodiments of the invention include a method of manufacturing a stack described herein.

Some embodiments of the invention include a method of using a stack including tubular cell elements or cell tubes. Merely for illustration purposes, the method is described based on the embodiments wherein the stack includes cell tubes. The method can include providing a first agent to the first section, wherein the first agent can enter the shell side of the cell tubes; and providing a second agent to the second section, wherein the second agent can enter the bore side of the cell tubes. The method can include removing heat from the stack. The removing of the heat can include introducing a fine spray of droplets of a cooling medium into at least one of the first agent or the second agent before entering the stack or entering the cell tubes. The removing of the heat can include having at least one of the first agent and the second agent bubbles through a cooling medium before entering the stack or entering the cell tubes. When the stack includes one or more cooling tubes, the removing of the heat can include running a cooling medium in the one or more cooling tubes. If at least a portion of the wall of the one or more cooling tubes allows a cooling medium to exit from the bore side of the one or more cooling tubes to wet the outside of the one or more cooling tubes, the removing of the heat can include introducing droplets of the cooling medium to at least one of the first agent and the second agent while it transits the stack. The cooling medium can include liquid water.

### BRIEF DESCRIPTION OF THE DRAWINGS

FIG. 1 illustrates the cross-section of an exemplary tubular cell element.

FIG. 2 illustrates an exemplary embodiment of fuel cell element interconnection.

FIG. 3 illustrates an exemplary embodiment of a fuel cell element interconnection.

FIGS. 4A to 4F illustrate steps that can be used in some exemplary embodiments to construct a cell tube including a plurality of tubular cell elements.

FIGS. 5A to 5D illustrate steps that can be used in other exemplary embodiments to construct tubular cell elements and a cell tube including a plurality of tubular cell elements.

FIG. 6 illustrates an exemplary method for forming a stack and connecting the tubular cell elements in series or in parallel.

FIG. 7 illustrates an alternative exemplary method for forming a stack that includes cooling and/or humidification tubes.

FIG. 8 illustrates an alternative exemplary method for forming a stack that includes cooling and/or humidification means.

FIG. 9 show the voltage versus current density for a fuel cell element constructed according to Example 1.

FIG. 10 show the voltage versus current density for a fuel cell element constructed according to Example 2.

### DETAILED DESCRIPTION

There are four basic types of hydrogen fuel cells: the alkali fuel cell, the phosphoric acid fuel cell, the solid oxide fuel cell, and the proton exchange membrane (PEM) fuel cell. Additionally there are fuel cells that use methanol as the fuel feed rather than hydrogen. Embodiments of the invention are described mainly with reference to fuel cells that use hydrogen as the fuel feed but it is to be understood that different embodiments described herein can apply equally well to fuel cells that use methanol or other fuel feeds. Fuel cell types are distinguished by the method used to form a selective ion bridge between the fuel (e.g. hydrogen or methanol) and the oxygen half cells. The alkali fuel cell uses an alkali salt, the phosphoric acid type uses phosphoric acid, the solid oxide type uses a metal oxide ceramic membrane, and the PEM type traditionally uses a membrane of cation ion exchange polymer. The function of these layers is to act as a barrier to mixing of the fuel and oxygen while allowing the selective transport of either hydroxide ions (OH⁻), oxygen ions (O²⁻) or protons (H⁺) between the cell electrodes. Today, the PEM type is a most popular candidate for fuel cells for, e.g., mobile applications.

Irrespective of the type of junction used, the vast majority of fuel cell constructions are based on a plate-and-frame design, where successive sheets of junction and electrode materials are sandwiched and sealed together with passages for the input and waste gases incorporated in the sandwich.

This design can present some limitations and difficulties. In the planar plate-and-frame design, the area of electrode that can be incorporated in a given volume is limited by the flat geometry and the need for passage layers. In part because of this limitation, the gas passages tend to be very small leading to significant pressure drops through the system and passage blockage by product water. To overcome this pressure drop, the input gases can need to be pressurized and pumped through the cell stack, adding to the cost and complexity of the system. An additional difficulty with the plate-and-frame stack design can be the large number of seals involved to prevent leakage of gas, a problem which can be exacerbated by the need to pressurize the input gases. This can be a particular issue when plastic elements, such as plastic plates to create passages, are used for cost and weight considerations. These plastic elements can often be subject to cold flow over time when held under the stack compression to maintain the seals between the plates. This cold flow tends to create leaks.

A notable exception to the plate-and-frame design is the tubular solid oxide fuel cell produced by Siemens-Westinghouse. This design is for stationary applications only and can include an assembly of dead-ended ceramic tubes where air can be pumped down the centre of the ceramic tubes and fuel to the outside. An electrode can be formed on the inside and an electrode on the outside of a solid oxide ceramic tube with a slot in the outer electrode and the ceramic tube down their length to allow electrical connection between the outer electrode of one ceramic tube and the inner electrode of another ceramic tube, thus achieving an in-series connection. The tubular structures can be relatively big (typically 2.2 cm diameter by 150 cm long in a small version) and the system needs to be operated at close to 1000° C. to allow sufficient ion conduction in the ceramic. Also, as the system is based on a ceramic tube it can be relatively fragile and prone to cracking.

Hollow fibre fuel cells are those disclosed in U.S. Pat. Nos. 519,514, 5,928,808 and U.S. Pat. No. 7,229,712, each of which is hereby incorporated by reference. These cells can include long narrow fibres where the fibres can be connected in series or in parallel via the ends of the fibres. A disadvantage of this configuration, compared to plate-and-frame fuel cells, can be that in plate-and-frame fuel cells with bipolar plates, the electrical connection between the cells can be the bipolar plate and thus can have a large cross-sectional area and a short length in the direction of electron travel. These connections therefore can have very low electrical resistance. In hollow fibre fuel cells with end connections the electrons flowing into the cathode and out of the anode need to travel along the length of the fibre. The conduction paths therefore can be much longer and have a small cross-section, introducing more electrical resistance into a stack of the hollow fibre fuel cells.

Embodiments of the invention are directed towards novel tubular designs that can be used as a fuel cell (or an electrolyse cell) that can ameliorate or overcome at least some of these deficiencies in the prior art. Embodiments of the invention are described in terms of tubular cell elements. The terms “fuel cell element,” “cell element,” and “tubular cell element” are used interchangeably throughout. It is understood that this is for illustration purposes only, and is not intended to limit the scope of the disclosure. A cell element can have an enclosed cross-section other than a circle. For example, a cell element can have a cross-section of square, rectangle, oval, triangle, hexagon, or the like. The terms “cell tubes” or “fuel cell tubes” are used interchangeably herein, and primarily refer to the structure thereof, instead of function thereof. The term tube “structure” is used to primarily refer to the structure which has an enclosed cross-section. A tube structure can have a cross-section of, for example, circle, square, rectangle, oval, triangle, hexagon, or the like. Different tube structures can include different constituent layers.

One problem to be solved if renewable energy sources are to be used in place of fossil fuels can be that of energy storage. Because electricity generation from renewable energy sources, e.g., solar, wind energy, and the like, can be intermittent, a method is needed to store excess electricity in times of high generation potential, to use when there is low generation potential. Numerous attempts to find a suitable method of achieving this have been made; but to date none has been fully satisfactory. A potential scheme for storing excess electricity that has been contemplated can be to use the excess electricity to split water into hydrogen and oxygen, store the formed gases separately and recombine them to generate electrical energy when it is needed. Fuel cells can be an excellent candidate for the process of converting the gases back into electricity and the fuel cells disclosed herein can be highly suitable for this application. Another application of the cells described herein can be as an electrolyser that can convert electricity into hydrogen and oxygen by electrolytically splitting water.

Some embodiments of the invention include a tubular cell element comprising an inner electronically conductive layer, an outer electronically conductive layer, an electronically insulating layer, and an ion conductive layer. The tubular cell element can further include at least one of an inner current collector layer and an outer current collector layer.

As used herein, an “electronically conductive layer” refers to one where the layer includes a material with a high conductivity for electrons. As used herein, “an electronically insulating layer” refers to one with low or negligible conductivity for electrons. In some embodiments, the electronically insulating layer has a high conductivity for ions. In some embodiments, the electronically insulating layer or portions thereof has a low conductivity for ions. The electronically conductive layer can be porous. The electronically conductive layer can be macroporous, or microporous. Merely for illustration purposes, some embodiments of the invention are described in which the electronically conductive layer includes a macroporous electrically conductive layer. It is understood that it is not intended to limit the scope of the disclosure.

The function of the macroporous electronically conductive layer can include imparting structural strength and/or acting as the electrodes or supporting the electrodes or as current collectors in the fuel cell, where the inner layer can include one half-cell electrode and the outer layer the other. The macroporous structure of these electronically conductive layers can also allow access for gas into the depths of the structure and/or the exit of water vapour that is the product of the reaction between a first agent and a second agent (e.g., hydrogen, methanol liquid or vapour, air and oxygen). Alternatively, there can be separate layers that act as current collectors. In such embodiments, an additional layer is added to the inside of the tube structure and/or the outside of the tube structure. These layers can advantageously have relatively low electronic resistance and be constructed so as to let gas pass through. One or more of the current collector layers can also impart structural strength to the tube structure. The macroporous electronically conductive layer and the current collector layer can be constructed of materials that are stable in the fuel cell environment. In some embodiments, that environment can differ depending upon in which part of the fuel cell the material resides. For example, if the material is exposed to oxygen or air to a substantial extent, then oxidation resistant materials such as carbon, stainless steel or titanium are suitable. If, however, the materials when in use are exposed mainly to reducing agents, for example, hydrogen, and thus a reducing environment, then they can also be made of other materials with lower oxidation resistance but improved other properties such as higher electrical conductivity. Examples of suitable other materials include carbon, stainless steel, titanium, nickel, copper, tin, and other metals, or an alloy thereof. Merely by way of example, the macroporous electronically conductive layer can be a stainless steel sheet that has been perforated, where the perforations can allow gases or liquid water to pass. As another example, the macroporous electronically conductive layer includes copper or nickel. The current collector layer can also be formed by winding a wire or wire mesh so as to form a tube structure when used as the inner current collector layer or around the outside of the already formed tube structure when forming the outer current collector layer. In some embodiments, the inner current collector layer is formed from a perforated sheet of stainless steel and the outer current collector layer is formed by winding a wire around the outside of the tube structure. The tube structure can be formed by other constituent layers including, for example, one or more macroporous electronically conductive layers, and/or at least one ion conductive layer. When winding a wire around the outside of the tube structure, there can be sufficient gaps between the wires to allow gas to pass through. In some embodiments, a wrapped wire or wire mesh or perforated sheet or any combination thereof is used as both the inner and the outer current collector layers.

In some embodiments, a support is included down the bore of the tube structure to help support the inner current collector layer or macroporous electronically conductive layer. This support can be made of electronically conductive or electronically insulating material and can be formed so as to allow sufficient access of gas to the fuel cell electrodes down the length of the tube structure.

The ion conductive layer, also referred to as the “ion exchange layer,” can include an electronically insulating layer. The function of the electronically insulating layer can include preventing electrical short circuit between the inner and outer electronically conductive layers. In some embodiments, the ion conductive layer includes a PEM. It is understood that the ion conductive layer can include a layer other than a PEM. The electronically insulating layer can also act as a carrier or supporting structure for a PEM, or form the PEM or other ion conductive material itself in the cases that, for example, the electronically insulating layer is constructed of an ion exchange material or an ion conductive ceramic. Furthermore, the electronically insulating layer can prevent a first agent and a second agent on different sides of the electronically insulating layers from excessively mixing with each other.

According to some embodiments disclosed herein, the PEM is formed by depositing ion exchange material in the pores of the electronically insulating layer in such a way that the pores are blocked sufficiently to prevent excessive mixing of the hydrogen and oxygen gas. Alternatively, the electronically insulating layer itself can also form the PEM. For example, a preformed membrane of ion exchange material can be wound around the inner macroporous electronically conductive layer to form the electronically insulating layer.

A catalyst, such as, platinum, ruthenium, and the like, can be deposited such that at least some of the catalyst sits at the interface of the PEM and either the inner or outer electronically conductive layer or both. The catalyst can be deposited on the PEM or can be deposited on the macroporous electronically conductive layers. In both cases the catalyst can be placed such that it is in contact with the PEM, in electronic contact with the macroporous electronically conductive layer and that a reactant gas (the first agent or the second agent) can contact the catalyst. In this position the catalyst sits at the PEM/electrode (electronically conductive layer) interface. The catalyst deposited can be self-supporting or can be deposited on another support, such as powdered carbon, as is known in the art. If the catalyst is deposited on a support, then it is the support that is deposited on the PEM or on the macroporous electronically conductive layer. If a catalyst support is used, the catalyst can be deposited on the support before or after the support is deposited on the PEM or the macroporous electronically conductive layer. In some embodiments, the catalyst is deposited on the catalyst support before the catalyst support is deposited on the PEM or the macroporous electronically conductive layer.

In some embodiments of the invention described herein, one or more preformed layers can be used to form a tube structure. In these embodiments, it can be advantageous to have the preformed layers in the form of strips that are helically wound to form the tube structure. As used in this disclosure, “helical winding” means winding a material around the circumference of an elongate shape where the material is wound such that its edge is at an angle of greater than zero degrees but not at ninety degrees to the long axis of the elongate shape. One or more of the layers can be helically wound. Helical winding is suitable as it lends itself to continuous or semi-continuous production methods, facilitates even tension in the wound layer and can lead to a strong structure that can resist crushing. Even tension in the wound layers can be important to be able to maintain even and intimate contact between and within the layers of the fuel cell to facilitate efficient transfer of electrons or ions across the interfaces. In this respect the outer layer of the tube structure can be important. For example, if the outer layer is a current collector formed by helically winding wire or a strip of perforated metal, relatively high tension can be applied to the wire or strip as it is being wound, leading to a relatively high radial force being applied across the other layers to compress them and facilitate electron or ion transfer. Additionally, it is often desirable to form tubular structures of small radius, as the area of fuel cell that can be incorporated in a given volume is inversely proportional to the radius of the tubular structures. The radial force applied by a wire or strip wound around the tube structure increases as the hoop stress increases. The hoop stress is given by the tension in the wire or strip divided by the radius around which it is wound. For a given tension, the smaller the radius the higher the radial force. Thus by using this method to form the outer or other layer, increased layer compression is compatible with increased fuel cell area per unit volume.

The macroporous electronically conductive layers and the additional current collector layers, if present, allow gas pass through them. Thus, there is no need to seal the windings of these layers to one another when they are helically wound. In contrast, the PEM or other electronically insulating layer can substantially prevent the passage of gas across it. Thus, if this layer is helically wound, there can be a seal between the adjacent winds. If the PEM is formed from a helically wound strip of membrane of ion exchange polymer, or other relatively soft material, tight winding of the strip such that adjacent winds have an overlap area (overlap region) can be sufficient to form a seal. This can be a suitable method when the outer macroporous electronically conductive layer or current collector layer is tightly wound so as to compress the inner layers, as the compression compresses the overlap area, facilitating a seal. If it is desired to further improve the seal, the PEM layers in the overlap area can be sealed to one another by suitable methods as described elsewhere in this disclosure. It is to be understood that it is not necessary that the PEM layer be helically wound but merely convenient in some embodiments. The PEM layer can also be wrapped in other fashions, such as with the overlap seam (overlap region) being aligned with the long axis of the tube structure or that the PEM layer can be a tube structure formed without a seam, where the tube structure is either preformed or formed in place.

In some embodiments, when the fuel cell is in use, hydrogen gas or other fuel liquid or vapour is brought into contact with the catalyst at the PEM/electrode interface through the pores in one of the electronically conducting layers, and oxygen (e.g., in the form of air) is brought into contact with the catalyst at the other PEM/electrode (electronically conductive layer) interface though the pores in that electronically conducting layer. At the respective interface, hydrogen or other fuel can react to form protons and electrons, and oxygen can react to consume electrons and produce hydroxide ions. The protons formed on the hydrogen or other fuel side of the PEM can diffuse through the cation exchange material (the PEM) and combine with the hydroxide ions to form water and heat, which can be removed by flowing oxygen, air, or water across the surface of the electrode/current collector.

The structure above describes a fuel cell element that forms some embodiments of the invention disclosed herein. In some embodiments, the structure includes two electronically conductive layers and an ion conductive layer (or an electronically insulating layer) in between. In some embodiments, one of the two electronically conductive layers is porous, or macroporous. In some embodiments, both electronically conductive layers are porous, or macroporous. Some exemplary embodiments of the electronically insulating layer are described elsewhere in the disclosure. Such a structure can also be used as an electrolyser. Merely for the purpose of simplicity and convenience, the term “fuel cell element” is used to refer to the structure, irrespective of its intended use as a fuel cell or an electrolyser, or both. In some embodiments, an electronically conductive layer is referred to as an electrode, or a conductor; and an electronically insulating layer is referred to as an insulator. In some embodiments, a fuel cell element does not include a separate current collector layer, and the electronically conductive layer can function as a current collector layer.

Some embodiments relate to how the fuel cell elements can be configured and connected to make a stack. Merely for the purpose of simplicity and convenience, the term “stack” is used to refer to a number of fuel cell elements connected to each other. The connection between/among the fuel cell elements can be in series, or in parallel, or a combination thereof. A stack can be used in a way that all the fuel cell elements function as fuel cells, or that all the fuel cell elements function as electrolysers, or that one or more of the fuel cell elements function as fuel cell(s) and one or more of the fuel cell elements function as electrolyser(s). A stack can include one or more sub-groups of fuel cell elements, hereinafter referred to as assemblies. Within an assembly, the fuel cells can be connected to each other. The connection between/among the fuel cell elements within an assembly can be in series, or in parallel, or a combination thereof. The assemblies of a stack can be connected with each other. The connection between/among the assemblies within a stack can be in series, or in parallel, or a combination thereof. Merely by way of example, a stack can include six assemblies, and each assembly can include four fuel cell elements in serial connection to form a cell tube. In the stack, a group of three cell tubes can be in serial connection, and the two groups can be in parallel connection. An advantage of such an arrangement is that if one fuel cell element fails, the stack can still function at, at least, a partial capacity. An additional advantage includes ease of repair as only the assembly with the failing fuel cell element or rod needs repair or replacement. A further advantage includes a convenient set-up. For example, assemblies can be provided by a manufacturer or a supplier; and the connection of the assemblies to set up a stack can be chosen to achieve a desired output (e.g., output voltage, output current, or a combination thereof), and the connection can be finished on the site where the stack is going to be used. A stack can be used in a way that all the assemblies function as fuel cells, or that all the assemblies function as electrolysers, or that one or more of the assemblies function as fuel cell(s) and one or more assemblies function as electrolyser(s). In some embodiments, an assembly includes a cell tube. The cell tube can include a multiplicity of fuel cell elements. The fuel cell elements can be assembled end to end in electrical connection so that the assembly of the multiplicity of fuel cell elements forms a cell tube with a shell side and a bore side. A first agent on the shell side of the cell tube can be substantially prevented from mixing with a second agent on the bore side of the cell tube.

Desirable features of a stack can include, for example, a higher output voltage that a plurality of fuel cell elements connected in-series can yield, a lower internal electrical resistance, and reduced or minimised potential sealing issues. An additional desirable feature of a stack can include relatively large passages for gas flow, to reduce or minimise the pressure reactant gases needed to be supplied to the stack and to reduce or minimise the chance of passages becoming blocked with liquids or solids thus limiting gas access.

Some embodiments of the invention include a cell tube. The cell tube can include a multiplicity of fuel cell elements described herein. The fuel cell elements can be assembled end to end in electrical connection, wherein the assembly of the multiplicity of fuel cell elements can form a cell tube with a shell side and a bore side. A first agent on the shell side of the cell tube can be substantially prevented from mixing with a second agent on the bore side of the cell tube. In some embodiments when the cell tube is used as a fuel cell, at least one of the first agent and the second agent include a gas, a vapour, or a liquid. The first agent or the second agent comprises one gas selected from, for example, hydrogen, oxygen, methanol liquid or vapour, and air.

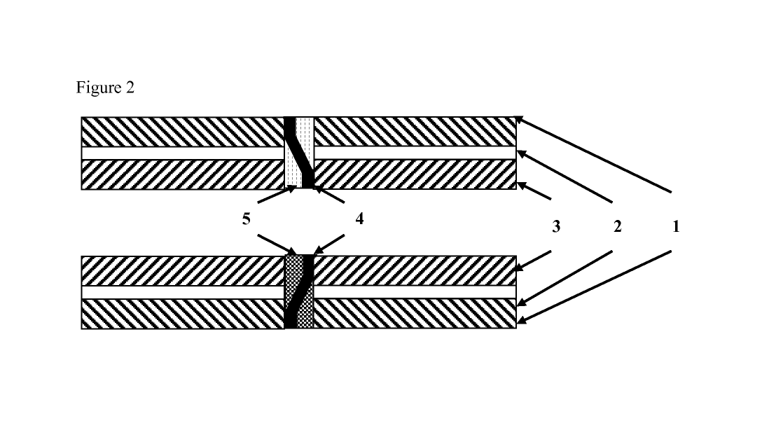

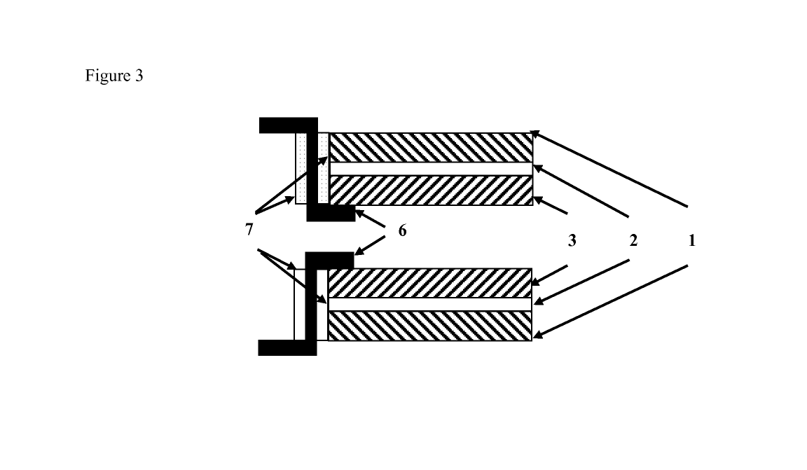

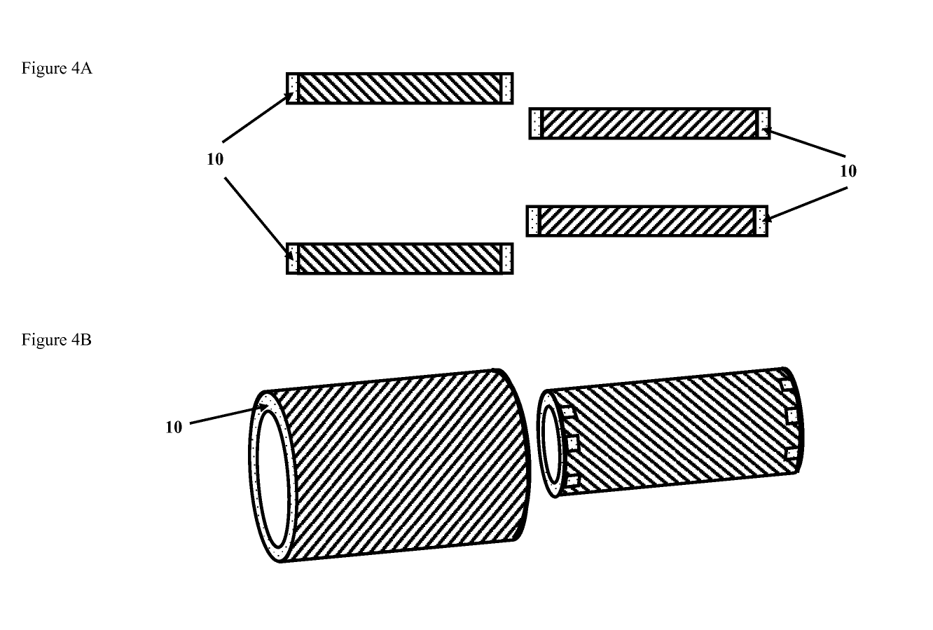

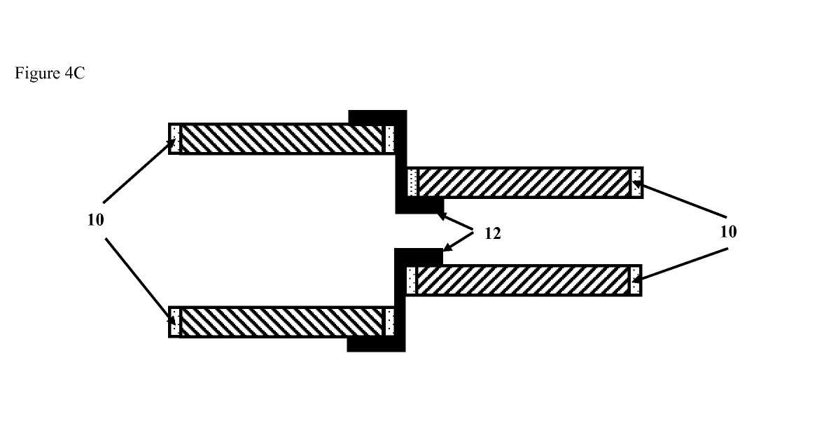

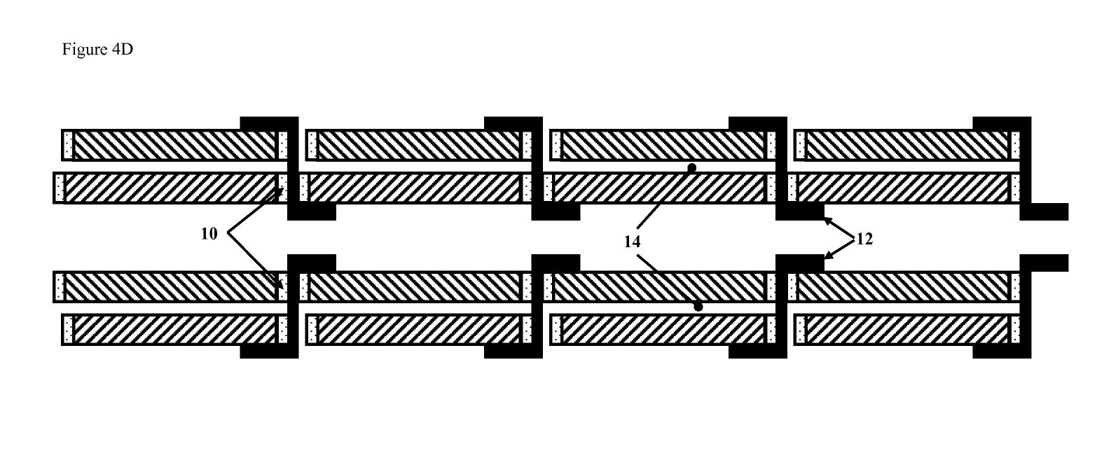

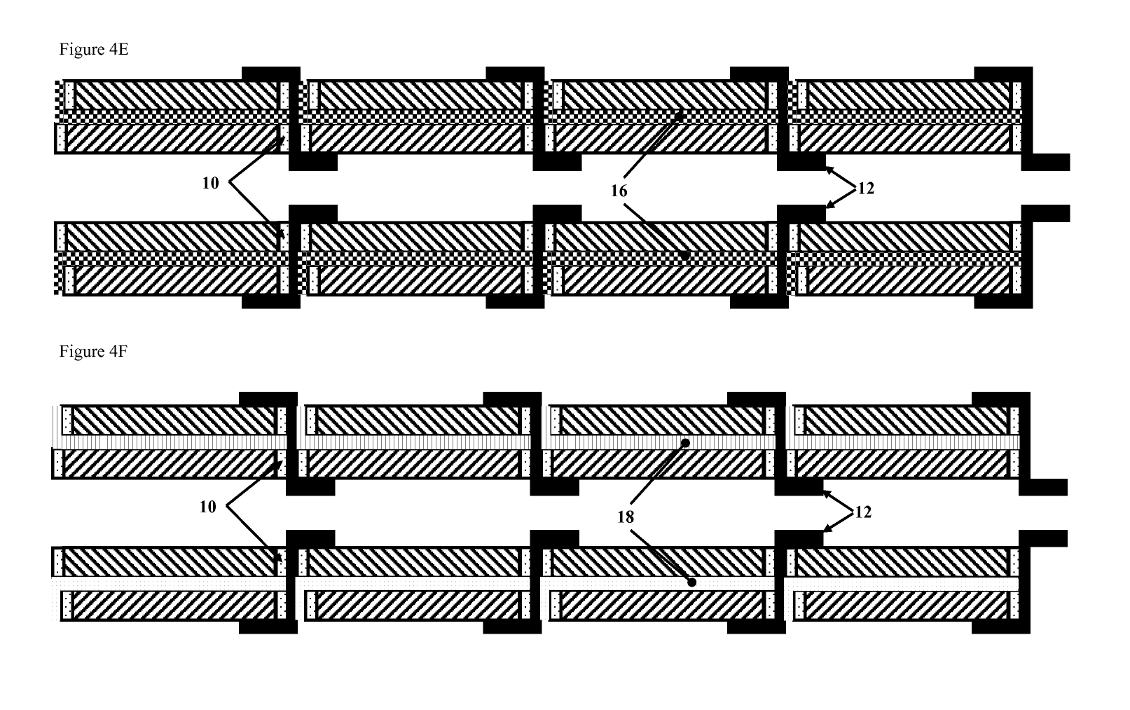

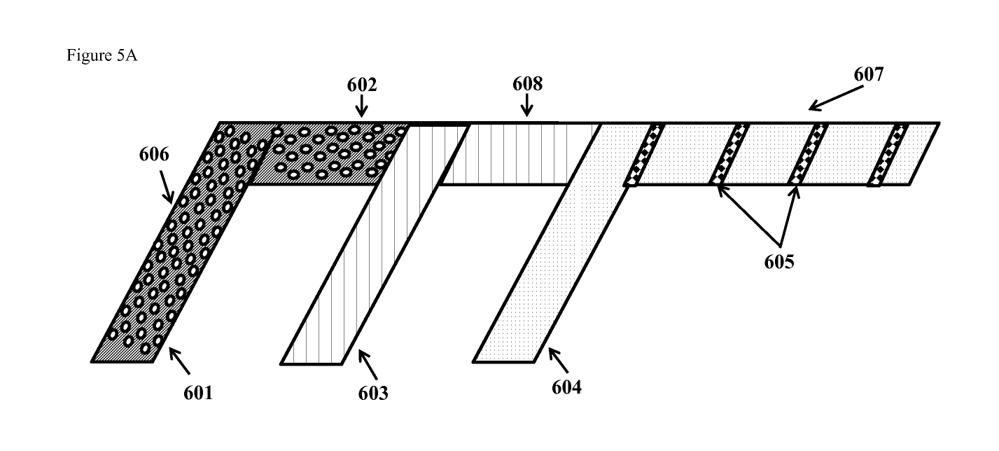

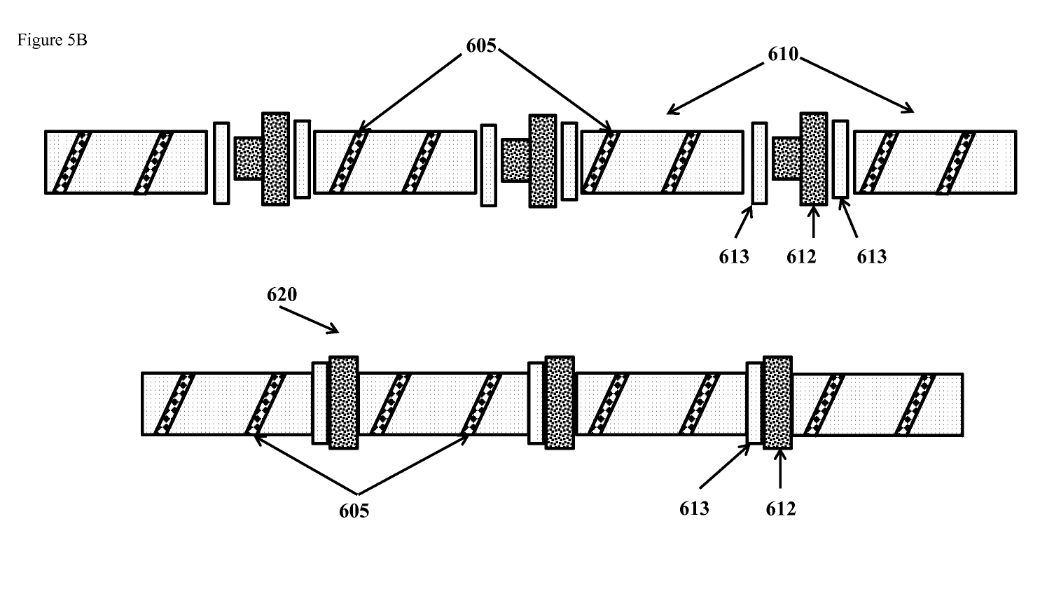

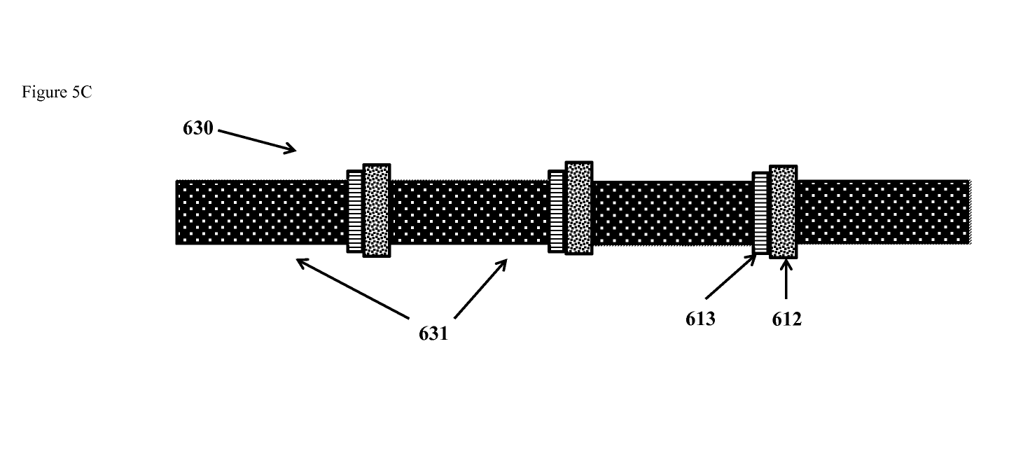

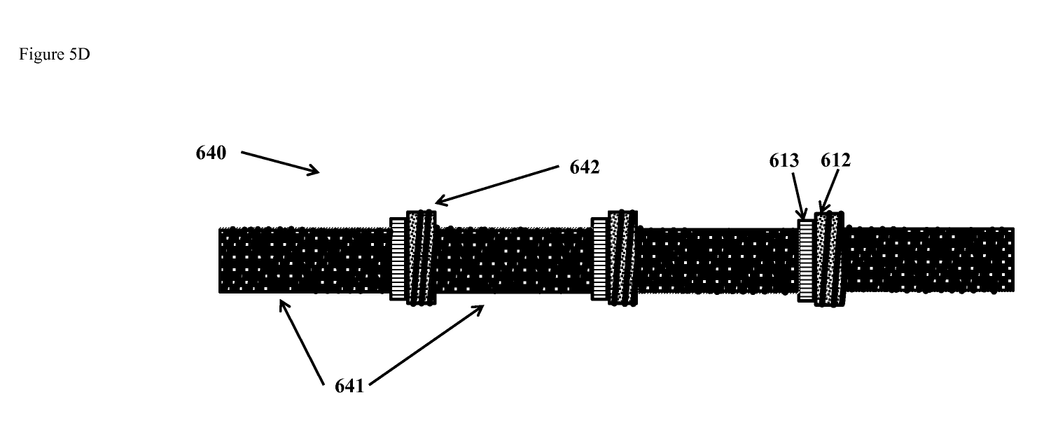

In some embodiments of the invention, a number of fuel cell elements are prepared and connected such that the outer conductor (the outer electronically conductive layer) of a first fuel cell element is electrically connected to the inner conductor (the inner electronically conductive layer) of a second fuel cell element, while the inner conductor (the inner electronically conductive layer) of the first fuel cell element is insulated from the outer conductor (the outer electronically conductive layer) of the second fuel cell element. Successive fuel cell elements can be joined in this way such that the assembly can include a number of fuel cell elements connected in series. As used herein, such an assembly is referred to as a “fuel cell tube” or “cell tube.” The electrical connection can include an electrically conductive connecting piece. See, for example, 4 in FIG. 2, 6 in FIG. 3, 12 in FIG. 4C, 612 in FIGS. 5B and 5C. The cell tube can include at least one electronically insulating sealing piece. The electronically insulating sealing piece can include at least two faces, wherein one face forms a seal with the electrically conductive connecting piece, wherein the other face forms a seal with the ion conductive layer of the tubular cell element. See, for example, 5 in FIG. 2, 7 in FIG. 3, 613 in FIGS. 5B and 5C. A cell tube can also only contain a single fuel cell element. A common feature of the cell tubes referred to here, whether they contain one or a multiplicity of fuel cell elements is that the cell tube is the tubular fuel cell assembly having a common bore. Merely by way of example, when utilizing an organic polymer PEM that may be damaged by heat, the cell tube can be formed using heat to connect and/or fuse the fuel cell elements together before formation of the PEM, so that when the PEM is formed it can block any openings formed due to an incomplete seal between the lengths and/or the interconnects. In some embodiments, such a cell tube is formed after formation of the PEM. Alternatively, the fuel cell elements can be formed into a cell tube after the incorporation of the PEM. In these embodiments, the assembly methods should not substantially damage the PEM. Suitable methods include, for example, mechanical methods and those using adhesives or temperatures that do not damage the PEM enough to substantially impair operation of the final fuel cell assembly, and the like, or a combination thereof.

In some embodiments, a stack can include one cell tube. In some embodiments, a stack can include two or more cell tubes, wherein the cell tubes are connected in series, or in parallel, or a combination thereof. The ends of the plurality of the cell tubes are sealed into at least a first sealing plate, wherein the first sealing plate divides the stack into at least a first section and a second section, wherein the shell side of the cell tubes are open to the first section, wherein the bore side of the cell tubes are open to the second section. Merely by way of example, when utilizing an organic polymer PEM that may be damaged by heat, the stack can be formed before the formation of the PEM. In some embodiments, a stack is formed after formation of the PEM. Multiple cell tubes in a stack can be the same (e.g., including the same number of fuel cell elements that are connected in the same way) or they can be different. Merely by way of example, the number of the fuel cell elements in one or more cell tubes can be different than that in one or more other cell tubes of the stack. As another example, the cell tubes can include the same number of fuel cell elements, but the fuel cell elements in one or more cell tubes are connected in a different way than those in one or other cell tubes.

The cell tubes can be placed substantially parallel to one another. The cell tubes in the stack can be spaced from one another so as to form a multitude of open passages between the cell tubes. These passages and those formed by the bores of the cell tubes can allow relatively free access of the reactant gases or vapours to the fuel cell elements or product gases or vapours from the fuel cell elements if used as an electrolyser. The multitude and interconnectivity of the passages formed by the spaces between the cell tubes on the shell side can result in a low resistance to gas/vapour flow and thus reduce or minimise the pressure drop that gases or vapours experience travelling through the shell side of the stack. This can be important if air is used as the reactant gas on the shell side, as only oxygen from the air is consumed in the fuel cell, meaning that other gases in air, such as nitrogen, need transit and exit the stack. This needs a higher overall gas flow than on the bore side where reasonably pure fuel, for example hydrogen, is typically supplied. In prior art fuel cell stacks, this often can result in the need to compress the air before it enters the stack in order that it can maintain the desired flow rate through the stack. The equipment used to compress the air can add cost to the system and consumes some of the energy produced by the system. In contrast, with embodiments of the invention disclosed herein, the openness of the gas flow paths in the stack mean that only minimal pressurization of the air is needed, such as can be supplied by a blower or fan or by natural convection, saving energy and allowing the use of lower cost equipment. A further advantage of the open architecture of the stack, compared to the prior art, is that the passages within the stack are less likely to become blocked with liquids such as water or solid contaminants in the reactant gases. Liquid water can be a problem in prior art fuel cell stacks as water is produced by the fuel cells and the input gases are often pre-humidified. So if conditions in part of the stack lead to the formation of liquid water droplets, they can coalesce and form a large enough drop to block a passage that, depending upon the pattern of passages, can block further access of gas to part of the stack. In contrast, in a stack according to some embodiments of the invention, the relatively large size and interconnectedness of the passage make the design much less likely to lead to blockages formed by liquid water.

In some embodiments, the stack includes one or more cooling tubes. The cooling tubes can be placed substantially parallel to one another. The ends of the one or more cooling tubes can be sealed into at least a second sealing plate, wherein the first sealing plate and the second sealing plate can divide the stack into a first section, a second section, and a third section. The shell side of the cell tubes can be open to the first section, the bore side of the cell tubes can be open to the second section, and the bore side of the cooling tubes can be open to the third section. At least a portion of the wall of the one or more cooling tubes can allow a cooling medium to exit from the bore side of the one or more cooling tubes to wet the outside of the one or more cooling tubes. The cooling medium can include, for example, liquid water.

The ability of the stack design of some embodiments of the invention to be tolerant to the presence of liquid water can also confer additional advantages over the prior art. Heat balance is another area that can be important to control in order to maintain optimal operation of a stack. Heat can be generated as a by-product of the reaction of the reactant gases at the electrodes. It can be desirable to retain some of this heat in order to run the fuel cells at an elevated temperature where they operate more efficiently, but not retain too much of the heat, such that the fuel cell elements can be damaged by the high temperature or dried out such that the efficiency of ion migration through the PEM is decreased. Thus in many stacks, for example, those designed to have a high power output, it can be important to actively or passively control the heat being removed from the stack. Water balance can be also important in fuel cells where the PEM is sensitive to water content, such as when organic ion exchange polymers are used to form the PEM. In some embodiments of the invention, it is possible to combine the functions of heat removal and humidity control in a stack. In this aspect of the invention, water is introduced into the shell side of the stack as an aerosol of liquid water droplets at one or more points. The water aerosol introduction point or points can open into the shell side of the stack (e.g., through the portion of the wall of the one or more cooling tubes that can allow a cooling medium to exit from the bore side of the one or more cooling tubes or through an opening in a wall enclosing the shell side of the stack) or can open into the gas flow (the first agent or the second agent) before the gas enters the stack. If introduced before the gas enters the stack, the water can be introduced into the bore side gas flow (the second agent), or shell side gas flow (the first agent), or both. If the gas already has high humidity, the water droplets can remain liquid, absorb heat and get warmed up. If the gas in the shell side of the stack is of lower humidity, some of the water droplets can evaporate, absorbing more heat and humidifying the gas. In this way, a natural balance is formed where dry gas is optimally humidified and heat absorbed when needed. After the water droplets have passed through the stack and been warmed, they can be allowed to coalesce at the base of the stack, where the liquid water can be pumped through an external cooling circuit and reintroduced into the stack as an aerosol. Alternatively, the external cooling circuit can be dispensed with water used in a single pass mode, where it is introduced to the stack when needed and allowed to flow to waste after exiting the stack. The amount of heat removed can be controlled by varying the amount of water introduced to the stack. This control can be automated by sensing the temperature in the stack and increasing or decreasing the cooling water flow to the stack on the basis of the sensed temperature.

For application as an electrolyser, the same macroporous conductor/insulator/macroporous conductor structure with optional current collector layers (fuel cell element) can be used where the advantages of the structure as a fuel cell are also applicable as an electrolyser. These advantages include high current densities due to the macroporous electrodes with high surface area, an open structure with relatively large passages (due to the void volume in a macroporous electrode and voids between and within the cell tubes in the stack) to allow for the formed gases to escape and be collected, low internal resistance to reduce or minimise energy losses in the electrolysis process, highly catalytic electrode surfaces to reduce electrode over-potential and a robust structure that can withstand the generation of gas bubbles continuously. As used herein, a “current density” refers to the current per unit geometric area of an electrode. In this application the bore (or internal) and shell (or external) side, or just the shell side can be filled with liquid water or water vapour and a suitable voltage applied across the electrodes to cause the electrolysis.

In some embodiments, a stack of fuel cell elements that are connected in series, or in parallel, or a combination thereof, can be used for electrolysis in times of excess electricity being available and as a fuel cell in times when extra electricity is needed. In some embodiments, the stack can be brought into contact with liquid water or water vapour when acting as an electrolyser; and the stack can be drained of liquid water when used as a fuel cell. Alternatively, liquid water can be maintained in the stack when used both as a fuel cell and as an electrolyser. In a further alternative, separate stacks can be used for the electrolyser and fuel cell when each stack can be optimised for its intended purpose. For example, the number of in-series fuel cell elements and/or that of in parallel fuel cell elements of the stacks can be arranged separately in order to allow for or achieve the desired supply and delivery voltages. When used as an electrolyser a suitable voltage is applied to the stack that is sufficient to electrolyse the water.

In some embodiments, a stack includes a plurality of the cell tubes that includes tubular fuel cell elements.

In some embodiments, a stack includes a plurality of the cell tubes that includes tubular electrolyser cell elements. At least one of the bore side of the cell tubes and the shell side of the cell tubes can be flooded with liquid water. In some embodiments, both the bore side and the shell side of the cell tubes are flooded with liquid water.

One thing affecting the power that can be extracted from a fuel cell device is the area of active electrode that can be incorporated in the volume allowed. Some advantages of fuel cell elements and/or a stack thereof, as disclosed herein, that can be achieved can be exemplified by the following estimation. It is understood that this estimate is merely for illustration purposes and is not intended to limit the scope of the disclosure.

In state-of-the-art plate-and-frame devices, the width of a cell assembly is approximately 4.4 mm. This translates to a maximum electrode area of 227 m² per m³ of cell stack. In practice, only a fraction of this area is available as active electrode due to the presence of a seal at the perimeter of each plate and that plates with channels formed into them are needed to define gas flow across the face of the electrode plate. Thus, only a portion of the electrode is in direct contact with the reactant gases. If these restrictions are considered, then perhaps only one half of each plate area is active. Thus, the active area can be estimated at 114 m² per m³ of cell stack.

Merely by way of example, according to the embodiments of the invention, a fuel cell element or cell tube can have a tubular cross-section with tube dimensions whose outer diameter (OD) is approximately 4 mm and inner diameter (ID) is approximately 1 mm. Further if the fuel cells or cell tubes with such tube dimensions are packed into a stack in which the fuel cell elements or cell tubes are in a hexagonal close packing pattern with an effective packing diameter of 4.2 mm, then the active electrode area that can be achieved is 257 m² per m³ of a cell stack, or a factor of 2.3 times the active area of a state of the art plate-and-frame device of the same volume. Thus, with everything else being equal, it is possible to extract 2.3 times the power for a device according to some embodiments of the invention compared to one using the current state of the art of the same volume.

An additional advantage of embodiments of the invention over plate-and-frame devices can be the relatively open architecture. For a stack according to some embodiments of the invention including the fuel cell elements or cell tubes with the tube dimensions exemplified above and assuming both macroporous conductor layers (macroporous electronically conductive layers) have 25% void volume, the stack can include a void volume or open space of 42%. For a plate-and-frame design there can be 10% void volume or open space in the stack.

A person of ordinary skill in the art would understand that according to the instant disclosure, fuel cell elements or cell tubes of other tube dimensions, or of other enclosed cross-sections (e.g., square, rectangular, oval, triangular, hexagonal, and the like) can be made; the fuel cell elements or cell tubes can be packed into a stack in a different packing pattern other than hexagonally. A different combination of these or other parameters can achieve different properties including the packing diameter, active electrode area, surface area or void volume available for a gas or fluid flow through the fuel cell element, the cell tube, or a stack thereof, and the like, or a combination thereof.

This additional open space of a stack according to some embodiments of the invention can allow for better gas access and water egress, alleviating issues with the blocking of the gas passages in the plate-and-frame design, where the gas passages can typically be blocked by product liquid water.

The open architecture can also facilitate cooling by allowing easy access to either the bore (internal) or shell (external) side of a fuel cell element or a cell tube for excess air to carry heat away. However, the open architecture can also allow a cooling method not available in plate-and-frame devices. In high power plate-and-frame fuel cells, separate channels are often incorporated in the cell plates through which cooling water can be circulated in a separate circuit to the gases and product water. This can require a separate pump and involve added complexity and space taken up by the extra channels. With the open shell (external) side of a fuel cell element or a cell tube according to embodiments of the invention disclosed herein, it is possible to flood the shell (external) side with water while dispersing small bubbles of the reactant gas (e.g., air, oxygen or hydrogen, and the like) throughout the shell (external) side to provide the reactant flow.

The water on the shell (external) side can provide an efficient heat transfer medium by which excess heat can be conducted out of the device or stack, but more importantly, can solve one of the most difficult problems with plate-and-frame PEM fuel cells—achieving the correct water balance in a system including such a device or stack. In PEM fuel cells, the PEM needs to remain fully hydrated to remain conductive. If it dries out, its resistance to ion flow can increase rapidly until the device can no longer work. On the other hand, in a plate-and-frame device, the gases cannot be so humidified that liquid water condenses in the system, as that can cause the small gas passages to block with liquid water and stop the reactant gas flow. In some embodiments disclosed herein, the shell (external) side of a fuel cell element or cell tube within the stack can be flooded with water, with finely dispersed gas bubbles providing the reactant gas flow (the first agent or the second agent), and then the PEM can remain adequately hydrated. In a stack the gas bubbles can be introduced and allowed to exit through openings in the sealing plates that in part enclose the shell side of the stack. The presence of liquid water in such embodiments is desirable rather than a problem to be overcome. Additionally, in this mode it can be easy to switch the device/stack to electrolyser operation as the water on the shell (external) side of a fuel cell element or cell tube and soaking the PEM now becomes the reactant to produce hydrogen and oxygen gas. Other cooling and humidification methods can also be used as described later in this disclosure.

In some embodiments, it can be desirable to arrange that the surface of the shell (external) side macroporous electronically conductive layer is hydrophobic. Reactant gas bubbles can fill the pores in the macroporous electronically conductive layer in preference to water, thus allowing increased access for reactant gases to the electrode/catalyst sites while maintaining optimum humidity surrounding the PEM.

Also disclosed herein and forming part of the invention are methods of manufacture of fuel cell elements, assemblies (or cell tubes) and stacks. It is to be understood that these are not the only possible methods but merely convenient methods of manufacture.

### Supporting Structure

Some embodiments of the invention involve building fuel cell elements within tubular structures. The tube cross-section can be circular for ease of manufacture, but can also be square, rectangular, oval, triangular, hexagonal, or other enclosed cross-section shape. For example, from packing density considerations of assemblies or stacks of tubular fuel cell elements it can be advantageous to use a square, triangular or hexagonal cross-section.

Irrespective of the cross-section shape chosen, the tube structure can have a macroporous inner layer constructed of material that is capable of conducting electrons (inner macroporous electronically conductive layer), a macroporous layer that is made of an electronically insulating material (ion conductive layer or electronically insulating layer), and an outer macroporous layer that is formed from an electronically conducting material (outer macroporous electronically conductive layer). Optionally, there can be additional inner and/or outer current collector layers.

As used herein, “macroporous” refers to pores that are large enough to allow the free flow of gases and liquids through them. The lower limit of pore size can be dictated by when gases and liquids cannot flow freely. The upper limit to pore size can be dictated by when significant portions of the ionic conductive layer can no longer contact at least one point of the electronically conductive layer, either directly or via electronically conductive particles in the ionic layer such as the catalyst particles. To achieve this in the context of some embodiments of the invention, the pore size range can typically be from 1 micron to 5 mm, or from 10 microns to 2 mm, or from 200 microns to 1 mm.

The porosity of the electronically conductive layers and, if present, current collector layers can cover a wide range from having 10% void volume to 95% void volume. The actual porosity chosen can be a balance between the electrical resistance of the macroporous electronically conductive layer and the ingress and egress of gases and liquid water or water vapour from the interface between the macroporous conductor and the insulating layer. If the electronically conductive layer is made from a material that has high bulk conductivity, then greater void volumes can be used to improve the access of gases and liquids and decrease the weight of the device without excessive electrical resistive losses. If the material chosen has lower conductivity but has other desirable properties such as high corrosion resistance, then a lower void volume can be more appropriate.

In some embodiments, the electronically conductive layers and, if present, current collector layers can be formed by sintering metal particles. The pore size can be conveniently adjusted by adjusting the appropriate particle size used, and the void volume can be adjusted by adjusting the compression force used to pre-form the layer before sintering.

In some embodiments, metal foams are used to form the macroporous electronically conductive layers and, if present, current collector layers. The amount and nature of the forming agent can be selected to achieve the appropriate pore size and void volume.

In some embodiments, one or more of the electronically conductive layers and, if present, current collector layers can include a monolithic macroporous material. Non-limiting examples of suitable monolithic macroporous materials include sintered materials, leached materials, expanded structures, or packed powders.

In some embodiments, assembled macroporous materials, for example, non-woven fibrous materials, woven filament materials, can be used. Woven or non-woven cloths of carbon fibres or filaments can be suitable materials.

In some embodiments, materials constructed by sintering metallic particles can be used for the electronically conductive layers. Some advantages of sintered metallic particles include that the particle size can be conveniently adjusted to adjust the size and porosity of the layer, and they can provide a large surface area upon which the fuel cell electrodes can be constructed.

In some embodiments, one or more of the electronically conductive layers or current collector layers can be constructed from an incomplete layer of a solid non-porous material where gaps are left between the sections covered by the solid material, but the regions of the solid material are connected so as to form a continuous conducting path. For example, the outer electronically conductive layer including the solid material is in the form of a wire that is wound around the outside of the tube structure formed by the electronically insulating layer and the inner electronically conductive layer. Alternatively, the wire can be wound inside the bore of the tube structure and in contact with the electronically insulating layer that forms the inner surface of the tube wall. In both cases, gaps can be left between the winds of wires to allow ingress of gas (e.g., hydrogen, oxygen, air, and the like, or a combination thereof).

Non-limiting examples of materials that are suitable for the electronically conductive layers include carbon, stainless steel, titanium, nickel, copper, tin, and other metals, or alloys of metals that have suitable conductivity and corrosion resistance in the fuel cell environment.

The electronically insulating layer can be macroporous. The macroporosity of the electronically insulating layer can depend upon the embodiments being used. In some embodiments, the electronically insulating layer is formed of particles whose primary function is to provide a support for the ion exchange polymer. A material with larger pores can be used, so as to increase the amount of ion conducting material in the layer in the completed fuel cell. For example, pore sizes can be in the range of 1 micron to 1 cm, or in the range of 10 microns to 5 mm, or in the range of 100 microns to 1 mm; the void volumes can be as large as possible while still maintaining the desired mechanical strength to survive the manufacturing process. For example, void volumes can be in the range of 50% to 95%, or in the range of 60% to 90%, or in the range of 70% to 80%.

In some embodiments, the electronically insulating material used is itself a proton conductor, and forms the ion conductive layer. A much broader range of pore sizes and void volumes can be useful. If no ion conductive polymer is used and the insulating material is relied upon to form a gas barrier and conduct ions, then the material need not be macroporous but rather just contain paths for the ions to conduct, such as the interstitial spaces between the atoms or sheets of atoms in a clay matrix. Microscopic pores are also permissible in these embodiments as long as they are small enough that the layer can still form a suitable gas barrier, for example, by the pores becoming filled with liquid water. In some embodiments, a mixed ion conductive layer including a support material and an ion conductive polymer is used. The pores and void volume can be chosen on the basis of a minimum strength of the layer needed for the structure while maximising its ion conductivity. For example, if the support material has an ion conductivity, comparable to that of the ion conductive polymer, the void volume can be smaller and thus a stronger support structure used. In some embodiments, the support material can be made of the same material as the ion conductive polymer. If the ion conductive polymer has a much greater conductivity than the support material, the void volume can be increased provided that the layer has an acceptable strength primarily from the support material.

Non-limiting examples of materials that are suitable for the electronically insulating layer include, for example, a silicate material, an aluminosilicate, a metal oxide, a ceramic material, a macroporous polymer, an ion exchange polymer, and the like. Merely by way of example, the ion conductive material can include zeolite or Nafion®.

In some embodiments, it is desirable to have the electronically insulating layer between the two macroporous electronically conductive layers to have a high conductivity for protons, as this layer serves as the PEM in the system.

Some embodiments of the invention include a method of manufacturing a tubular cell element. The method can include forming a tube structure using a first electronically conductive material to form an inner electronically conductive layer, forming an electronically insulating layer or ion conductive layer around the tube structure comprising the inner electronically conductive layer; and forming an outer electronically conductive layer using a second electronically conductive material. The first electronically conductive material or the second electronically conductive material can include one material selected from, for example, carbon, stainless steel, titanium, tin, copper, nickel, and other metal, or an alloy thereof. The electronically insulating material or ion conductive material can include one material selected from, for example, a silicate material, an aluminosilicate, a metal oxide, a ceramic material, a macroporous polymer, an ion exchange polymer, and the like. Merely by way of example, the electronically insulating material or the ion conductive material can include zeolite or Nafion®. Depending on the specific material used, the electronically insulating layer can be ion conductive, or can be provide a structural support on which ion conductive material can be coated. The forming of the electronically insulating layer or ion conductive layer can be achieved by winding a sheet of electronically insulating material or ion conductive material around the tube structure comprising the inner electronically conductive layer. Adjacent winds of the ion conductive sheet can be placed so as to at least partially overlap one another to form an overlap region. Heat sealing or adhesive sealing can be added to the overlap region. The forming of the outer electronically conductive layer to form an outer electronically conductive layer can be achieved by wrapping the second electronically conductive material onto the tube structure including the inner electronically conductive layer and the ion conductive layer.

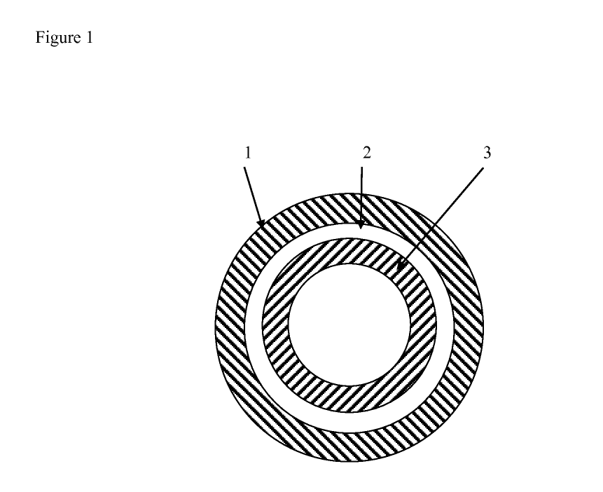

To give just one example of a method of construction, stainless steel powder is taken, formed into a tubular shape and sintered as is known in the art to produce a macroporous electronically conductive layer into a tube structure. Aluminosilicate (clay) mixed with water to make a slip is then wound or coated onto the external surface of the sintered tube structure such that the stainless steel is completely covered, and then the water driven off to leave a dry layer of aluminosilicate particles. More stainless steel particles are then packed around the aluminosilicate layer in a mold and the whole structure heated such as to sinter the outer stainless steel particles to render the structure such as illustrated in FIG. 1.

In some embodiments, the method of manufacturing a tubular cell element includes forming an inner electronically conductive layer and forming an outer electronically conductive layer before forming an electronically insulating layer. The method can include first forming an inner current collector layer onto which the inner electronically conductive layer is formed, and forming an outer current collector layer around the outer electronically conductive layer. This method can be suitable when using an insulating layer material that may be damaged by the temperatures used to sinter metal, for example, if an ion conducting organic polymer material is used.

To give another example of a method of construction, two pre-formed sintered metal tube structures are taken where the outer diameter of one tube structure is smaller than the inner diameter of the other tube structure by, for example, twice the desired thickness of the electronically insulating layer. The smaller diameter tube structure is placed inside and essentially concentric with the larger diameter tube structure and the gap between the tube structures filled with insulating material in the form of powder, particles or fibres.

### Incorporation of PEM

Once a tube structure including at least one of the inner electronically conductive layer, the electronically insulating layer, and the outer electronically conductive layer is formed, in some embodiments, other components of the fuel cell can be incorporated. Other components include, for example, an ion conductive layer (e.g., a PEM layer) that is capable of conducting ions but preventing the bulk mixing of gases in the bore side and shell side of the fuel cell element, and a catalyst that is in contact with the PEM and the electronic conductor (electronically conductive layer).

As described elsewhere herein, in some embodiments, to prevent the bulking mixing of gas, the ion conductive layer is formed by winding a sheet of ion conductive material around a tube structure comprising the inner electronically conductive layer. Adjacent winds of the ion conductive sheet can be placed so as to at least partially overlap one another to form an overlap region. Heat sealing or adhesive sealing can be added to the overlap region.

In some embodiments, the PEM can be formed by introducing a solution of an ion exchange polymer in a suitable solvent into the porous tube structure (including at least one of the inner electronically conductive layer, the electronically insulating layer, and the outer electronically conductive layer), and configuring the capillary force in the electronically insulating layer such that it is higher than that of the electronically conducting layer(s) present in the porous tube structure. This can, for example, be achieved by ensuring that the electronically insulating layer has smaller pores than the electronically conducting layers. In such a situation, the solution containing the ion exchange polymer tends to localise in the electronically insulating layer; and as the solvent evaporates, the polymer can precipitate so as to block the pores in the electronically insulating layer. To further encourage the polymer to selectively deposit in the pores of the electronically insulating layer, the polymer solution can be introduced into the porous conductor on one side of the electronically insulating layer, and heat and/or gas applied to the other side of the insulating layer so that the solvent can evaporate from the side of the electronically insulating layer distal to the side to which the polymer solution is applied. In this method, the solvent can evaporate preferentially from areas of the electronically insulating layer that are not yet blocked with deposited polymer, the effect of which is to block holes in the growing electronically insulating material/ion exchange polymer composite to help ensure that a complete pin-hole free layer is formed. The growing of the ion exchange polymer coating on the electronically insulating material can be from the side of the electronically insulating layer closer to where the heat and/or gas is applied toward the electronically conductive layer where the polymer solution is application. This, in turn, can help prevent mixing of gases from the bore and the shell side of the tube structure when the fuel cell is in operation. In concert with, or after a complete ion exchange polymer layer is formed, additional polymer solution, e.g., the same ion exchange polymer solution, can be loaded into one or both of the porous electronically conductive layers and the solvent evaporated to leave a film of polymer in contact with the polymer in the electronically insulating layer and coating at least a portion of the pore walls of the porous electronically conductive layer. This can increase the surface area of the electrode/PEM interface to help improve the current density achievable in an operation.

In some embodiments, the ion exchange polymer (or PEM) includes a cation exchange polymer that can allow the selective transport of protons or hydronium ions. In some embodiments, the ion exchange polymer (or PEM) include an anion exchange polymer that can allow the selective transport of hydroxide ions. Merely by way of example, the cation exchange polymer can be, for example, Nafion® (DuPont de Nemours), as it has a high selectivity for protons, high ion conductivity, and is relatively chemically inert and can be conveniently dissolved in solvents to form a solution.

In some embodiments, the ion exchange polymer can be self-supporting and not formed within the pores of a separate electronically insulating material. This alternative can be used in some embodiments in which a sintering step post incorporation of the PEM layer may not be needed. If a sintering or other high temperature treatment is to be performed after the PEM is formed in place, it is likely that the PEM may be damaged by the heat treatment. In this alternative, the ion exchange polymer (or PEM) can be placed onto the inside or the outside of an electronically conductive layer. It can be deposited by evaporation of a solution containing the polymer, by addition of the polymer in molten form or as a pre-formed sheet or tube structure that is placed over or inside the tubular electronically conductive layer. If a sheet is used, then the seam of the wrapped sheet can be sealed using molten or dissolved polymer to create a PEM tube structure. The other electronically conductive layer can then be formed on the PEM using a process such as winding a wire which did not damage the PEM to the extent that its functions in the fuel cell would be impaired.

In some embodiments, a layer of aluminosilicate material such as zeolite, is used both as the electronically insulating layer and as the PEM, as the appropriate choice of zeolite can provide the desirable proton exchange properties while maintaining a barrier to gas mixing. The use of zeolite can have the advantage that the material can withstand sintering temperatures; so the zeolite layer can be sandwiched between the layers of macroporous conductors (macroporous electronically conductive layers) and in one step form the macroporous electronically conductive layer/electronically insulating layer/macroporous electronically conductive layer sandwich structure with a complete PEM. In plate-and-frame structures according to the prior art and the Siemens-Westinghouse tubular structure, using a thin layer of zeolite as the PEM would be highly problematic as in both systems the membrane would easily fracture. According to some embodiments of the invention disclosed herein, however, the PEM is contained within and supported by the macroporous conductor layers and thus protected from fracturing. Moreover, some embodiments of the invention disclosed herein do not need high temperatures to function. Thus, the issues associated with expansion and/or contraction due to temperature cycling that can damage the fuel cell elements can be reduced or minimised.

In some embodiments, the inorganic PEM (such as zeolite) can be combined with an organic polymer PEM (such as Nafion®) to form a composite PEM. The inorganic cation exchange material can be incorporated into the sandwich structure during its construction and the polymer infused into any cracks in the inorganic PEM that can otherwise constitutes leaks in the PEM. The advantage of these embodiments over using a non-ion exchange material as the electronically insulating layer can include, at least, that the inorganic cation exchange material can contribute to the proton conductivity and thus, lower the internal resistance and increase the performance and/or efficiency of the fuel cell.

In some embodiments, a high content of polymer electrolyte, such as Nafion®, is included in the electronically insulting layer. In such an embodiment, a layer that is 100% Nafion® can be desirable. The following is an exemplary method for preparing such a layer, as disclosed herein.

In a first stage, a macroporous layer of material (electronically insulating material) can be placed between the inner and outer macroporous electronically conductive layers. The electronically insulating material can have the characteristics that it can survive the conditions used to prepare the macroporous electronically conductive layers, for example, conditions suitable for sintering metal particles, and can be dissolved or otherwise removed under conditions that do not affect the macroporous electronically conductive layers. For example, the electronically insulating material can be one soluble in a basic solution, or acid solution. Materials such as calcium carbonate can be suitable.

After the electronically insulating material is placed between the macroporous conductors and the assembly, for instance, sintered to finish the macroporous conductor layers, polymer electrolyte can be introduced into the voids in the electronically insulating layer as described in the disclosure. For example, Nafion® can be introduced as a solution from which the solvent is driven off to leave solid polymer, which is then made insoluble by heating in an oven as is known in the art. After this step, when the voids in the electronically insulating layer are filled with the insoluble polymer, the electronically insulating material can be exposed to a leaching liquid, for example a basic aqueous solution, so as to dissolve away the electronically insulating material. This can leave voids in the polymer electrolyte structure (PEM). More polymer electrolyte can then be used to fill those voids and be converted to an insoluble form. In this way, the ion conductive/exchange layer is formed wholly of ion conductive polymer, while being able to maintain electronic isolation between the macroporous electronically conductive layers.

In some embodiments, an electronically insulating layer composed of just an organic ion exchange polymer can be formed by forming a layer of particles of organic ion conducting polymer and then introducing more organic ion conducting polymer into the voids between the particles by depositing it from a solution of it or a different ion conducting polymer. Nafion® is merely one example of a suitable ion conducting organic polymer, as particles of Nafion® may not dissolve in the Nafion® solution added to the particles. The result of this being a layer composed of Nafion®, which has relatively high ion conductivity.

### Incorporation of Catalyst

A fuel cell can further include one or more catalysts. Such catalysts can typically include small particles of platinum metal placed so as to be in contact with the PEM and one or both of the electronic conductors (electronically conductive layers). In some embodiments, platinum can be used for both the anode and the cathode. In some embodiments, the catalyst includes ruthenium.

In some embodiments, platinum metal is deposited via the reduction of a cationic platinum ion, for example, tetra-amino-platinum(II) (Pt(NH₃)₄²⁺) or chloroplatinic(II) anions, which are commercially available as salts or acids (Sigma Aldrich). In this method, the fuel cell element is placed into a solution of the platinum salt or acid in water. If a cationic metal ion species, such as Pt(NH₃)₄²⁺, is used, it can ion exchange into the cation exchange polymer (or PEM). If an anionic metal ion species is used it can stay in solution surrounding the PEM.

Metallic platinum particles can then be formed by reducing the platinum ions in the PEM or in the solution surrounding the PEM. The reduction can be achieved either chemically or electrochemically. In the chemical reduction method, a solution of a reductant, such as borohydride or hydrazine, that has a sufficiently strong reducing action to form the platinum metal, is placed in contact with the fuel cell element with the PEM loaded with platinum ions or with solution containing platinum ions surrounding the PEM. By adjusting the concentration of the reducing agent used in the reducing solution, the position and particle size of the platinum can be adjusted. For example, by lowering the concentration of the reducing agent, the reduction action can be slowed down. This can allow a greater time for the platinum ions in the PEM to migrate to the surface where the reduction action is initiated and grow at the surface, where it is more likely they can also be in contact with one or both electronic conductors.

In some embodiments, the platinum metal can be formed electrochemically. In this method, a power supply is connected between one electronically conductive layer and the other, with the layer being made the cathode the one where the platinum deposits. The polarity of the voltage applied between the conducting layers can be reversed periodically such that each layer is the cathode in turn, so that platinum can be deposited at both final fuel cell electrodes (electronically conductive layers). This method can have the advantage of ensuring that the platinum metal formed is all in contact with one or both electronic conductors and the PEM, thus making optimum use of the precious metal.

If insufficient platinum is deposited in a single treatment, the polymer can be reloaded with platinum containing ions or be brought into contact with more solution containing platinum containing ions after the reduction has occurred and the reduction step repeated. This sequence can be repeated as often as is needed to achieve the desired loading of platinum. Alternatively, rather than loading and reducing in serial steps, solution containing platinum containing ions that can be exchanged into the PEM can be introduced to one side of the PEM and either a chemical or electrochemical reduction of the platinum salt carried out on the other side of the PEM, where the reduction is continued until the desired loading of platinum is achieved.

With the PEM and catalyst in place the structure is capable of being used as a fuel cell element.

### Possible Constructions of a Cell Tube and Stack

Some embodiments of the invention include a method of manufacturing a cell tube described herein. Some embodiments of the method are described with reference to FIGS. 2-5D. It is understood that this is for illustration purposes and is not intended to limit the scope of the disclosure.

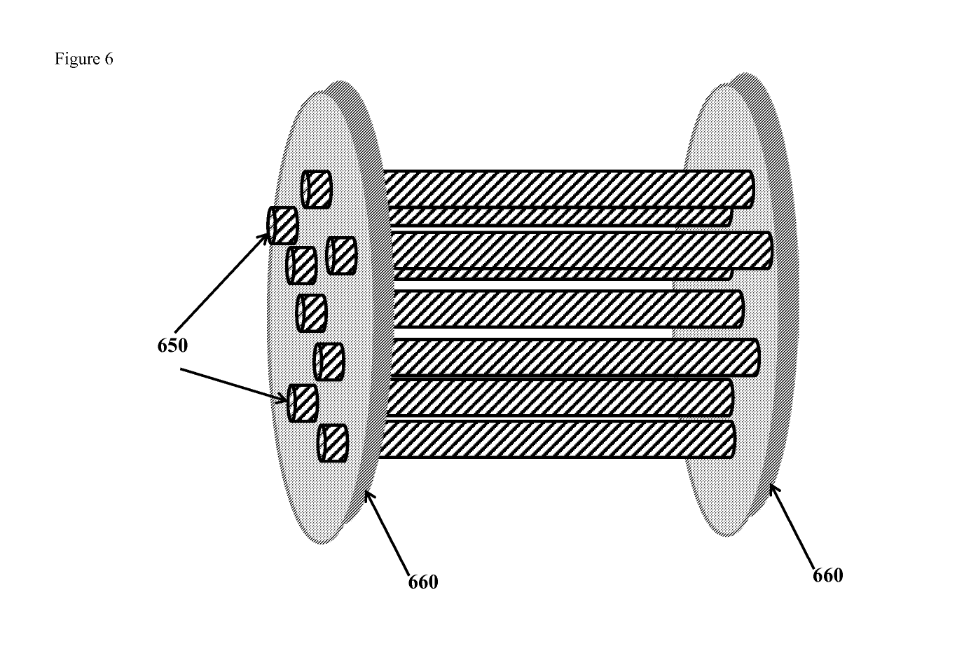

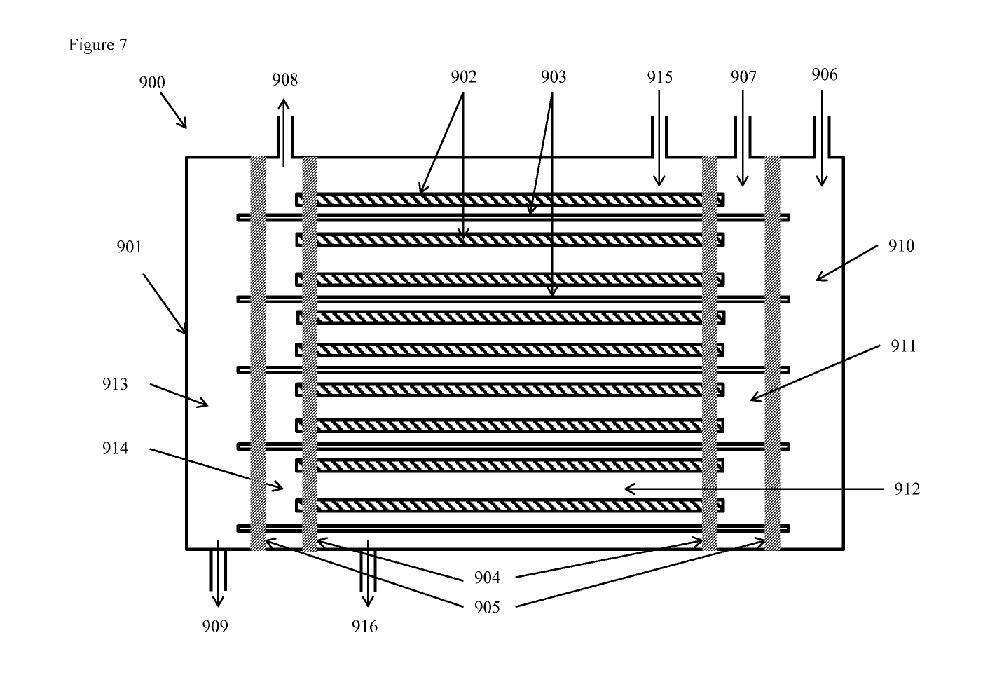

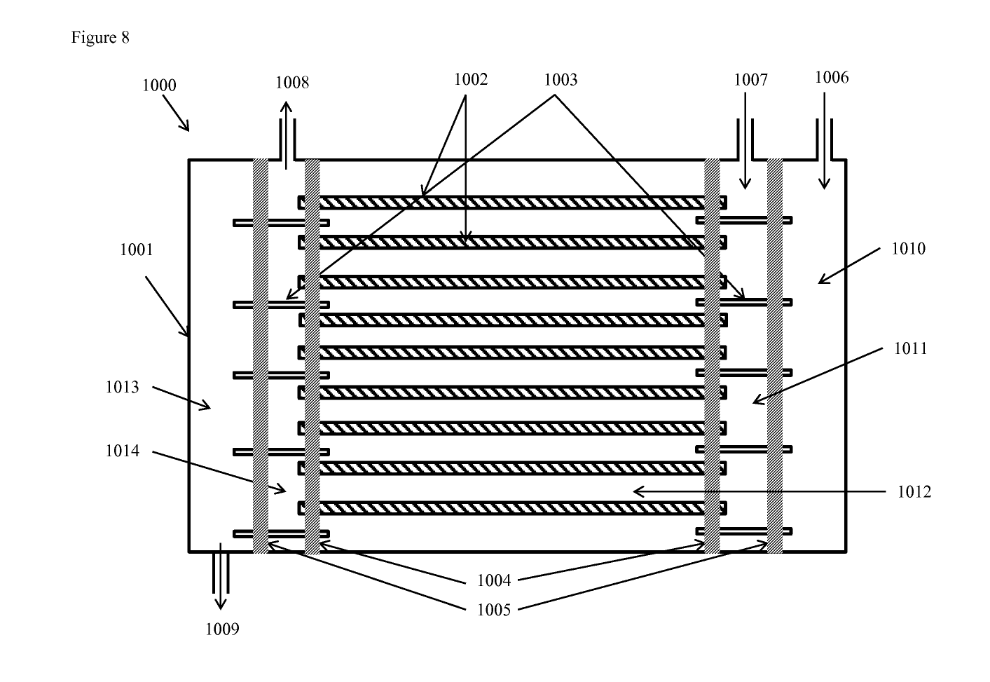

Some embodiments of the invention include a method of manufacturing a stack described herein. Some embodiments of the method are described with reference to FIG. 6, FIG. 7 and FIG. 8. It is understood that this is for illustration purposes and is not intended to limit the scope of the disclosure.

Some embodiments of the invention include a method of using a stack including tubular cell elements or cell tubes. Merely for illustration purposes, the method is described based on the embodiments wherein the stack includes cell tubes. The method can include providing a first agent to the first section, wherein the first agent can enter the shell side of the cell tubes; and providing a second agent to the second section, wherein the second agent can enter the bore side of the cell tubes. The method can include removing heat from the stack. The removing of the heat can include introducing a fine spray of droplets of a cooling medium into at least one of the first agent or the second agent before entering the stack or entering the cell tubes. The removing of the heat can include having at least one of the first agent and the second agent bubbles through a cooling medium before entering the stack or entering the cell tubes. When the stack includes one or more cooling tubes, the removing of the heat can include running a cooling medium in the one or more cooling tubes. If at least a portion of the wall of the one or more cooling tubes allows a cooling medium to exit from the bore side of the one or more cooling tubes to wet the outside of the one or more cooling tubes, the removing of the heat can include introducing droplets of the cooling medium to at least one of the first agent and the second agent while it transits the stack. The cooling medium can include liquid water. At least one of the first agent and the second agent can include a liquid, a vapour, or a gas. The first agent or the second agent can include a liquid such as methanol, or a gas, or a vapour selected from, for example, hydrogen, oxygen, methanol vapour, and air. Some embodiments of the method are described with reference to FIG. 6, FIG. 7 and FIG. 8.

A single fuel cell element in use can typically produce a voltage of the order of 0.5 to 0.8 V when current is being drawn. For most applications, this voltage is insufficient to be very useful. Thus, it is often desired to connect at least two and often many fuel cell elements in-series electrically to increase the output voltage of the device. Additionally, a plurality of in-series element assemblies or cell tubes can be connected either in electrical series or in parallel. By connecting assemblies or cell tubes in parallel, the current output of the device can be increased. The balance of in-series and in-parallel elements chosen depends upon a number of factors including, desired output voltage, and current for the particular application, as well as minimisation of losses due to electrical resistance within the device and in its external connections.

In general it is desirable to construct the stack so as to reduce or minimise internal electrical resistance, to reduce or minimise voltage drop within the stack.

In some embodiments, a method for assembling a stack of fuel cell elements that allows for a large number of in-series connections while reducing or minimising internal resistance is disclosed. Thus, in some embodiments, short lengths of the tubular fuel cell elements disclosed above are prepared. Depending upon the interconnection and PEM methodology used, the short lengths can be the incomplete fuel cell elements with just the electronically conductive layers in place, can be incomplete fuel cell elements with just the electronically conductive layers and electronically insulating layer in place, can be the complete fuel cell elements with PEM and catalyst in place, or can be an intermediate state, such as with an inorganic PEM but no catalyst. If it is desired to heat the structure, for example, to the conductor sintering temperature, to form the interconnections, then it can be preferable to load an organic PEM (if being used) and the catalyst after the in-series interconnections have been formed, to avoid damage to them from the high temperatures.

The short lengths of the fuel cell elements can be prepared as short lengths, or prepared by cutting a longer length of the partial or complete fuel cell structure into shorter lengths. Note that if using a cutting procedure, the cutting method can ensure that the inner and outer electronically conductive materials (if present) are not joined to form an electrical short circuit at the cut face. Apart from suitable mechanical means, such as a fine diamond saw or wire, other cutting techniques such as laser cutting, plasma cutting or water cutting can also be used.

In some embodiments, the stack includes short length of fuel cell elements, or optionally one or more cell tubes including a plurality of fuel cell elements. Within a cell tube, the plurality of in-series fuel cell elements can be interconnected such that the outer conductor (outer electronically conductive layer) of a first length (fuel cell element) is connected to the inner conductor (inner electronically conductive layer) of a second length (fuel cell element), while the inner conductor of the first length (fuel cell element) is insulated from the outer conductor of the second length (fuel cell element). This pattern of connections is repeated for each successive fuel cell element in the cell tube.

An exemplary embodiment of this aspect of the invention is shown in FIG. 2. In particular, FIG. 2 shows a longitudinal cross-section of the connection region of two fuel cell elements. Both elements shown in this figure include outer electronically conductive layer 1, electronically insulating layer (ion conductive layer) 2, and inner electronically conductive layer 3. The elements are side by side as shown in the figure. Electronically conductive connecting piece 4 is positioned between the elements. The fuel cell elements are connected in series through electronically connecting piece 4. Optionally, the space between the elements can include electronically insulating sealing piece 5. The upper and lower sets of the elements in the drawing correspond to upper section and lower section of the tube wall.

Typically, electronically conductive connecting piece 4 can have a lateral cross-section shape similar to the lateral cross-section shape of the fuel cell elements, although the lateral cross-section of electronically conductive connecting piece 4 can be smaller or larger than the lateral cross-section shape of the fuel cell element, as long as it not so large as to impede gas flow through the bore of the composite cell tube or so small so as to not be able to connect the outer electronically conductive layer to the inner electronically conductive layer.

In some embodiments, electronically conductive connecting piece 4 is constructed of a material that is suitably electronically conductive and has suitable corrosion resistance. Suitable materials include, for example, stainless steel, carbon, titanium, nickel, copper, tin, and other metals, or an alloy thereof.

Electronically insulating sealing piece 5, if present, can be formed from an electronically insulating material, such as, a rubber, ceramic, clay, lacquer, adhesive or other material. Its primary functions can be to help prevent unintended electrical connection between the various macroporous electronically conductive layers and to assist in forming a gas tight seal at the joints between the fuel cell elements. In some embodiments, electronically insulating sealing piece 5 is not needed. Electronically conductive connecting piece 4 can be sufficient to perform these functions adequately.

In some embodiments, electronically conductive connecting piece 4 can be formed by taking a metal sheet in the form of a washer (as is known for use with nuts and bolts) and using a process such as stamping to press the washer into a cup shape, of cross-section as shown for electronically conductive connecting piece 4 in FIG. 2. In this way, the position of the outer ring of the washer is offset longitudinally from the position of the inner ring. Optionally, an electronically or electrically insulating material can then be formed in the depressed regions formed by the cupping process to form a part that has a flat front and back face.

In some embodiments, a plurality of electronically conductive connecting pieces 4 (optionally with electronically insulating sealing pieces 5 in place) are placed between a plurality of fuel cell elements so as to form a cell tube. The cell tube including a plurality of shorter fuel cell elements electrically connected via electronically conductive connecting pieces 4. Once assembled, this cell tube can be heated to a temperature sufficient to fuse electronically conductive connecting pieces 4 to the outer and inner electronically conductive layers to form a robust cell tube. Alternatively, a rod can be placed down the bore of the cell tube such that the ends of the rod protrude from the ends of the cell tube. Nuts or similar devices can then be screwed onto the ends of the rod to apply force to the assembled fuel cell elements and hold them together to form the cell tube.

In some embodiments, once the cell tube is assembled, a polymer PEM is formed in the electronically insulating layers of the fuel cell elements (e.g., electronically insulating layer 2 in FIGS. 1-3) and the catalyst deposited as disclosed above. An advantage of this process includes that during the PEM-forming process, potential gas leaks at the fuel cell element connection points can be sealed.

In some embodiments, electronically insulating sealing piece 5 can be made of a soft non-porous material, such as butyl rubber or silicon rubber, to effect a connection seal. In this case, it can be preferable that high temperatures not be used to fuse the fuel cell elements to the composite cell tube but rather that some other methods, e.g., the mechanical compression method, be used.

In some embodiments, the fuel cell element interconnects (electronically conductive connecting pieces) are made from electronically conductive material where the interconnect fits over the external surface of a first fuel cell element and into the bore (internal surface) of the adjacent second fuel cell element, with insulators (electronically insulating sealing pieces) incorporated to prevent undesirable short circuits. This configuration is shown in FIG. 3. The figure shows only one fuel cell element, and its neighbouring element in serial connection with it is not shown. The element shown in this figure includes outer electronically conductive layer 1, electronically insulating layer (ion conductive layer) 2, and inner electronically conductive layer 3. Electronically conductive connecting piece 6 is positioned between the element and its neighbouring element (not shown in the figure). The elements are connected in series through the electronically conductive connecting piece 6. Optionally, the space between the elements can include electronically insulating sealing piece 7. The upper and lower sets of the elements in the drawing correspond to upper section and lower section of the tube wall. In these embodiments, electronically conductive connecting piece 6, a typically machined or otherwise formed part, is made that fits over the outside of one element and into the bore of the next element. Electronically insulating sealing piece 7 including insulating materials, such as silicone rubber washes, can be placed (or layer coated on to) in front of and behind the machined interconnect to prevent electrical shorting across the PEM and to aid in sealing. In the embodiments where the cross-section of the cell tubes or the constituent fuel cell elements are circular, the interconnects (electronically conductive connecting piece 6) can be threaded so as to engage with threads on the outside of a first fuel cell element and the bore (internal) wall of a second fuel cell element. For circular and other shapes of fuel cell elements, the interconnects (electronically conductive connecting piece 6) can be a press fit over the outside of a first fuel cell element and into the bore (internal) of a second fuel cell element.

FIGS. 4A to 4F illustrate steps that can be used in some embodiments to construct a cell tube comprising a plurality of fuel cell elements. According to this method, lengths of larger and smaller diameter macroporous electronically conductive tube structures can be taken and their ends coated with a lacquer or adhesive material (10, dotted space) that is electronically insulating as shown in cross-section (FIG. 4A) and perspective rendering (FIG. 4B). An electronically conductive connecting piece (12, the solid piece) can be placed on the ends of lengths of a larger-diameter tube structure and a smaller diameter tube structure assembled as shown in FIG. 4C. For example, a second length of the larger-diameter tube structure with electronically conductive connecting piece attached can then be placed over the smaller-diameter tube structure so they are concentric but with a gap between them. A plurality of lengths can be assembled in this way leaving a gap (14) between the smaller- and larger-diameter tube structures as shown in FIG. 4D. The gap between the inner and outer tube structures can be maintained by protruding areas of insulating material formed on the outside perimeter of the smaller diameter tube structure at its ends as shown in FIG. 4A and FIG. 4B. An electronically insulating material in particulate or fibre form, such as those described elsewhere in this disclosure, can be used to fill the gaps. As just one example, Nafion® powder can be used to fill the gap as shown in FIG. 4E (16, the space filled with checker board). A solution of an ion conducing material, such as a solution of Nafion®, can then be brought into contact with the gap filled with the electronically insulating material, and the solvent evaporated off to leave a deposit of the ion conducting material so as to form an integral barrier (18, the space filled with grid) suitable for separating gases (the first agent and the second agent) present on the inside and outside of the composite cell tube as shown in FIG. 4F.

FIGS. 5A to 5D depict alternative embodiments of fuel cell elements and cell tubes and a method of manufacturing thereof. In these embodiments and manufacturing method, at least some of the layers of the fuel cell elements are assembled by winding suitable material either to form a tube structure or around a pre-existing tube structure or former. In the exemplary embodiment illustrated, there are five layers to the fuel cell element, an inner current collector layer (or inner current collector) (601), an inner macroporous electronically conductive layer (603) which carries the catalyst supported of the side facing the PEM layer, a PEM layer (604), an outer macroporous electronically conductive layer (631) carrying catalyst on the side facing the PEM, and an outer current collector layer (or outer current collector) (641).

FIG. 5A illustrates an exemplary method of manufacturing a tube structure including one or more fuel cell elements. Firstly a tube structure (602) is formed by winding a strip of inner current collector material (601) that has openings (606) formed in it so that gas can pass through the layer. This strip can be wrapped around a former to form the tube structure, can be formed into a tube structure without the use of a former, or can be formed into a tube structure by wrapping inside a former. If an internal former is used, then the former can move with the tube structure as the tube structure is constructed or the former can be stationary and the tube structure move off the former as it is formed. If the former moves with the tube structure as the tube structure is constructed, then the former can be designed to be removed during the manufacturing process, or can be designed to stay in place in the final fuel cell element. If the former is designed to stay in place, it can include a groove or grooves in it such that gas can pass between the former and that perforated current collector layer, thus giving the gas access to the holes in the current collector layer. The groove or groves in the former can be of any convenient form such as straight, spirally wound around the former such as in the form of a screw thread or with two grooves spiralling in opposite directions around the former to form an intersecting series of grooves. Including at least one spiral groove on the former can be advantageous as it can be used to drive the former out as the inner current collector is wound around it in an automated fashion. In some embodiments, when the strip of inner current collector (601) is wound round the former, it is tacked in places to help it keep the desired tubular shape. It can be tacked by being welded in spots where the successive winds abut or overlap or can be tacked to a former, if present, by the application of heat for instance.

After the inner current collector (601) is wound a tube structure (602) is formed. The next stage of the manufacture can be to wind the inner macroporous electronically conductive layer (603) on to the inner current collector layer (or inner current collector) (602). This again can be conveniently done by having the macroporous electronically conductive layer in the form of a flexible strip. A material composed of woven carbon fibres, for example, as is known in the art as a gas diffusion layer, can be a suitable material for this layer. This layer can also support the electrode as catalyst such as platinum supported on carbon particles, which in turn are supported on the woven carbon fibres. So in some embodiments of a manufacturing method, a strip of the inner macroporous electronically conducting material is helically wound around the inner current collector (602) such that the successive winds of the layer abut one another. It is not a requirement that this layer be wound so as to leave no gaps, as part of the function of the layer is to let gas pass through it. However, it can be preferable that when wound the inner macroporous electronically conductive layer (603) is mostly continuous so that the electrode material supported on it is brought into contact with as much of the surface of the PEM as practical. If a machine is used for automating this part of the manufacturing process, it can be advantageous that the winding of this layer (603) is performed on the same machine as the winding of the inner current collector layer (602). Tube structure 608 includes two layers, the inner current collector layer (601) and the inner macroporous electronically conductive layer (603).

A PEM layer (604) is then formed by winding a strip of PEM material helically around the inner macroporous electronically conductive layer (603). It can be important that gas is substantially prevented from leaking across this PEM layer, as this can represent a loss of reactant gases when the device is used as a fuel cell and product gases when the device is used as an electrolyser. A convenient method for preventing leakage can be to overlap the successive winds of the PEM layer. In some embodiments, this can be sufficient to prevent substantial leakage. In other embodiments, it is preferable to further create a seal by applying heat to the PEM layer in the overlap regions (605) so as to fuse the overlapped layers. This sealing can also perform the additional function of holding the inner layers in place if the tube structure is subsequently cut into shorter lengths. Since the overlap region (605) represents a region of PEM where the PEM layer is twice as thick as in the non-overlap regions, it is preferable to minimise the area of overlap. This can be achieved by having a minimum overlap width and by winding the PEM at a shallow angle to the axis of the tube structure such that the length of seam per length of tube structure is reduced or minimised, while still being able to use a continuous strip to wrap around the tube structure in a continuous manner. As with the inner macroporous electronically conductive layer (603), if a machine is used for this manufacturing step, it can be advantageous to perform this step on the same machine as the other layers were wrapped in a sequential manner.

These winding steps can be done in a continuous or semi-continuous manner to form a tube structure (607) of any desired length. Tube structure 607 includes three layers, the inner current collector layer (601), the inner macroporous electronically conductive layer (603), and the PEM layer (604). In some embodiments, a fixed length of tube structure can be formed by the method above and used for the next stage, or a length of the tube structure can be cut as it is produced. A cut length of tube structure can form the basis a fuel cell element, or alternatively the tube structure can be initially cut into lengths suitable for a cell tube which is then further cut into lengths suitable for individual fuel cell elements as depicted in FIG. 5B. A convenient method can be where a length of tube structure is cut that can form the fuel cell elements in a cell tube and that this length is held in a segmented holder (not shown) such that the gaps between the segments or the holder correspond to where the joins between the fuel cell elements can be formed. Once in this segmented holder the tube structure is cut into lengths (610) corresponding to individual fuel cell elements. The segmented holder is then expanded laterally so as to open up gaps between the cut lengths (610) but where the cut lengths are kept in lateral alignment. Electrically conductive connecting pieces (612) and electronically insulating sealing pieces (613) are then introduced into the gaps between the cut lengths (610) and the cut lengths brought back together by laterally compressing the segmented holder. In this process a connecting piece (612) slides into the bore of one length of tube structure and over the outer diameter of the adjacent length of tube structure with the electronically insulating sealing piece (613) sealing between the connecting piece and the PEM on each end of the connecting piece. This seal can be enhanced by having the sealing pieces (613) made of a material such as a thermoplastic that can soften or melt and fuse to the PEM with the application of heat. A convenient method for applying this heat is by passing an electrical current through the connecting piece (612) such that it heats up sufficiently to allow the sealing pieces (613) to form a seal to the connecting piece (612) and the PEM on the cut lengths (610). The sealing pieces (613) can be merely by way of example in the form of flat washers or in the form of cups, where the end of the cut length (610) sits inside the cup of the sealing piece (613). The cup shape can facilitate sealing by increasing the area of contact of the sealing piece and the PEM layer. By this process a tube structure (620) is formed where the inner current collector (602) of one tube segment is electrically connected to the electronically conductive connecting (612), part of which sits around the outer diameter of the adjacent tube segment. Further, the inner current collectors (602) of the adjacent segments are electronically insulated from one another. It is advantageous to form the cell tube at this point in the manufacture as it allows good access to the PEM layer to form a satisfactory gas tight seal between the tube segments.

It now remains for the outer macroporous electronically conductive layer (631) shown in FIG. 5C and the outer current collector (641) shown in FIG. 5D to be formed for each segment. The outer macroporous electronically conductive layer (631) and/or the outer current collector (641) can be wrapped in a continuous manner down the tube structure (607) to form these layers. However, it can be important that these layers do not form an electrically conductive path across the connecting pieces (612) so as to cause a short circuit between the tube segments. Thus, the outer macroporous electronically conductive layer (631) and the outer current collector layer (641) should be discontinuous between the tube segments. One method to form this discontinuity can be to remove the outer macroporous electronically conductive material and outer current collector material from the region between the segments after wrapping the layers. An alternative method can be to wrap the macroporous electronically conductive material (631) and/or the outer current collector material (641) separately for each segment ensuring that the material does not form an electrically conductive path between the outer current collectors (641) of adjacent segments. An alternative method for forming layer 631 is by spraying or otherwise applying a powered or fibrous material to the PEM layer of each segment. Note that it can be important that the outer current collector (641) is in electrical contact with the part of the connecting piece (612) that sits around the outside of the PEM layer, as this can form part of the in-series connection. This can be achieved by overlapping the outer current collector (641) with the outer surface of the connecting piece (612). For example, if the outer current collector (641) is formed by wrapping wire around the outer macroporous electronically conductive layer (631), the wire can be wrapped such that it overlaps the outer surface of the connecting piece (612) at one end of the segment (642) but does not electronically contact the connecting piece (612) at the other end of the segment. After wrapping, the wire can be kept in place by, for example, welding, twisting, knotting the wire, and the like, or a combination thereof. By this method a completed cell tube is formed where the cell tube includes a plurality of fuel cell elements in electrical in-series connection. Tube structure 630 includes four layers, the inner current collector layer (601), the inner macroporous electronically conductive layer (603), the PEM layer (604), and the outer macroporous electronically conductive layer (631). Tube structure 640 includes five layers, the inner current collector layer (601), the inner macroporous electronically conductive layer (603), the PEM layer (604), the outer macroporous electronically conductive layer (631), and the outer current collector layer (641).

To form the inner current collector layer (602), a thin sheet of electrically conductive material of suitable thickness and with suitable corrosion resistance can be used. The preferred thickness of the sheet is dictated by considering its electrical resistance, strength, weight and stiffness. Since these parameters vary depending upon the material chosen, the preferred thickness can also vary. Stainless steel can be a suitable material to use as it has good corrosion resistance and strength and acceptable electrical conductivity. In some embodiments where the bore of the cell tube is substantially or only exposed to a reducing environment such as hydrogen gas in use, then materials with poorer corrosion resistance than stainless steel but with other desirable properties can be considered. For example, carbon, stainless steel, titanium, nickel, copper, tin, and other metals, or an alloy thereof, can be suitable because of their acceptable corrosion resistance in reducing environments and high electrical conductivity. For stainless steel, suitable thicknesses of sheet can be from 10 microns to 1000 microns, or 25 microns to 500 microns, or from 50 microns to 300 microns. Thicknesses in these ranges can give a good balance of strength, lightness, electrical conductivity and amenity to bend to form a tube structure.

The inner current collector layer (602) can have openings (606) formed in it. See, for example, FIG. 5A. These openings can be formed, for example, by slitting and pulling the material to expand it, by melting away material to form holes with a laser or other heat source, by punching the holes with a die that removes the punched out regions, or by perforating the sheet with a tool that breaks through the material but does not remove the material. For example, a tool that has shaped first protrusions can be used to form the perforations where the tool pushes the sheet material to the back side of the sheet to form a crown of material around each hole. This crown of material can subsequently be removed to leave a substantially smooth surface or can be left in place. It can be advantageous to leave the crown of material (first protrusions) in place and to wind the perforated sheet such that the crown of material faces the inner macroporous electronically conductive layer (603) when it is wound on to the inner current collector tube structure (602). If this is done, then the crown of material around each hole can penetrate the inner macroporous electronically conductive layer (603) to a suitable depth forming electrically conductive fingers that assist in collecting electrons from the inner macroporous electronically conductive layer (603) in a manner that lowers the electrical resistance encountered by the electrons during this transfer. This can be advantageous in some embodiments where the macroporous electronically conductive layer is made of fibrous or expanded material such as woven or non-woven carbon fibre or carbon filament material. This material can have the advantage of being open to gas flow and resistant to corrosion but can have a higher electrical resistance than desirable. By inserting fingers of a better conductor such as stainless steel into the macroporous sheet the overall electrical resistance can be decreased. A convenient method of achieving this is to use the fingers or crown of material formed during the perforation process as the fingers that get inserted into the macroporous sheet. However, there are other methods that can be used to achieve this. Other examples of suitable methods for forming fingers of material to be inserted into the macroporous layer include pins penetrating the current collector sheet (e.g., 601 or 602 in FIG. 5A) that protrude on the side of the current collector sheet facing the macroporous layer (e.g., 603 or 608 in FIG. 5A), dimples or depression formed in the current collector layer such that first/second protrusions are formed on the inner/outer current collector side facing the inner/outer macroporous layer, and any other means that forms protrusions on the side of the current collector facing the macroporous layer. It is to be understood that the term fingers used in this context refers to any protrusion of material that is capable of penetrating the macroporous layer to some extent. It does not have to have a long and thin aspect such as a human finger but can be of any suitable shape. The depth of penetration of the fingers into the macroporous layer can be deep enough to assist in electron transfer from the macroporous layer to the current collector layer but not so deep so as to significantly block gas flow or weaken the macroporous layer in a way that it impedes its function or such that the fingers may penetrate the PEM layer (e.g., 604 or 607 in FIG. 5A) to cause a gas leakage path or electronic short circuit from one side of the PEM layer to the other.

To form the inner and outer macroporous electronically conductive layers (e.g., 603 in FIGS. 5A and 631 in FIG. 5C) a material can be chosen that is electronically conductive, has suitable corrosion resistance, is macroporous, and is capable of supporting the catalyst that forms the electrodes of the fuel cell. An example of a suitable material to form these layers is a material formed from woven carbon fibres, such as are known in the art as gas diffusion layers. Woven fibre layers can be preferred over other types of macroporous carbon layers that are known due to their superior flexibility and thus amenity to being wound to form a tube structure. Avcarb 1071 HGB from Ballard Material Products Inc. is such an exemplary suitable material. As is known in the art this material can be coated with carbon particles on which a catalyst can be supported to form the fuel cell electrode on the face of the layer facing the PEM. The layer can also be treated so as to be hydrophobic to assist in the clearance of liquid water from the layer. EC2019 Electrode from Fuel Cell Earth can be an exemplary suitable material that can incorporate a catalyst.

The PEM layer can include a material that can form a barrier to gas transport and electron transport but allow ions to pass through them with an acceptable electrical resistance. Membranes made from ionomers can be suitable. Nafion® from du Pont de Nemours, a cation exchange fluoropolymer can be suitable due to its high proton conductivity, toughness and chemical inertness. A strip of the PEM material can be wound onto the tube structure such that each successive turn overlaps the previous turn (e.g., 605 in FIGS. 5A and 5B). This layer can be under compression in the completed fuel cell and this compression can serve to prevent significant leakage of gas through the joints between the turns. However, in some embodiments, it is desirable to improve this seal to further decrease gas leakage. If an organic polymer membrane such as an ionomer membrane is used, then heating the membrane in the overlap region can be a suitable method for achieving this seal as it can cause the polymer layers to partially or fully fuse to create an improved seal. The heat can be applied by any convenient method that can allow the heat to be targeted to the overlap region of the membrane. Suitable methods include, but are not limited to, a laser to apply the heat to the overlap region by targeting the light beam at that region, a heated tip touched against the overlap region to apply the heat or a heated gas stream directed to the overlap region. The heat source can be moved relative to the tube structure to seal along the seam, or the tube structure can be moved past a fixed heat source. An exemplary method is to rotate the tube structure as it is moved past a fixed heat source in such a way that the heat source tracks along the overlap region as it moves past the heat source. The improvement in sealing can alternatively be achieved by applying an adhesive to one or both faces of the PEM strip in the overlap area. If an adhesive is used, it is advantageous, though not required, to preserve the ion conduction function of the PEM in the seal area. One way to do this is to use an ion conductive material such as a polymer electrolyte as the adhesive. For example, this adhesive can be applied as a solution or suspension of a polymer electrolyte, which can subsequently form a sealing layer between the faces of the overlap region. In some embodiments, the adhesive can be a solution of the material used to form the PEM. The overlap region can represent an area of membrane that is thicker than the non-overlap regions and thus is likely to have an increased electrical resistance to ion flow. Thus, it is desirable to minimise the area of overlap. This can be done by limiting the width of overlap to just that needed to obtain an acceptable seal and by reducing or minimising the length of seam per length of fuel cell. A minimum length can be achieved by having the overlap region running straight down the length of the fuel cell element. However in some embodiments, this can create manufacturing difficulties as it can be difficult to perform this type of wrapping on a continuous basis with suitable tension applied. From the point of view of manufacturability, it can be preferable to wrap the PEM helically around the circumference of the tube structure. An acceptable compromise to satisfy both these considerations can be to wind the PEM at a shallow angle to the long axis of the tube structure to allow continuous wrapping while having close to the minimum possible length of overlap region per length of fuel cell element. Suitable thicknesses for the PEM layer in some embodiments are 5 microns to 500 microns, or 10 microns to 200 microns, or 25 microns to 100 microns.

The outer current collector layer (or outer current collector) (641) can be formed from an electrically conductive material with suitable electrical conductivity, strength and corrosion resistance. The outer current collector (641) shown in FIG. 5D is in the form of a wire wrapped around the outer macroporous electronically conductive layer. However, this is just one exemplary embodiment of possible outer current collector layers. Other examples are perforated sheet material or a narrow strip of flat solid material with gaps between the wraps. A wire can be a preferred material as it is readily obtainable in a variety of materials and thicknesses and is amenable to being wound. Circular cross-section wire can be preferred as the wraps of wire can be immediately adjacent to one another or touching one another but still maintain gaps for gas to flow freely through. The circular cross-section also can reduce or minimise the tendency of the wire to cut through the other layers when wrapped tightly. Stainless steel can be a suitable material for the outer current collector due to its excellent corrosion resistance. However, if it is in form of a wire, its limited electrical conductivity can introduce higher than desirable electrical resistance due to the length of wire the electrical current has to travel down to exit the current collector. To ameliorate this, the wire can be back wrapped over the initial wrappings at a shallower angle to the tube axis. This back wrapping can provide a relatively short path for the electrons to travel down that intersects the primary wrappings at many points, so efficiently collecting electrons from the primary wrappings and delivering them to the end of the fuel cell element.

A relatively simple method for forming a stack and connecting the cell tubes in series or in parallel is shown in FIG. 6. In these exemplary embodiments, a plurality of cell tubes (650) can be assembled into a bundle. If in-parallel connections are desired, the outside of the cell tubes (650) can be placed in electrical contact, for example, by lying next to one another in contact or by having a separate electrical connection, such as a metal wire, running between them. If in-series connections are desired, wires or other electrical connection pieces can run between the external surface of one cell tube (650) and the internal surface of a second cell tube (650). The cell tube (650) can include a single fuel cell element or can include a plurality of fuel cell elements assembled into a cell tube, such as is shown in FIGS. 4A-4F and FIGS. 5A-5D. As depicted in FIG. 6, sealing plates (660) can be formed at points along the length of the cell tubes (650) in the bundle so as to be able to isolate the ends of the cell tubes (650) from an external space surrounding at least a section of the cell tubes (650). The perimeters of these sealing plates (660) can further be sealed into a housing so as to close off the space between the sealing plates (660). By this means, a reactant gas (first agent or second agent) in contact with the ends of the cell tubes (650) and thus the bore (internal) of the cell tube (650) can be isolated from a gas in contact with at least a section of the shell (external) side of the cell tube (650). Merely by way of example, hydrogen gas can be introduced into the space surrounding the end or ends of the cell tubes (650) and oxygen gas can be introduced into the shell (external) side space isolated from the ends of the cell tubes (650). Solid (non-porous) electronically conductive pieces, for example, lengths of solid metal tube, can be connected to the end of the cell tubes, or inserted at points along the length, of the cell tubes such that the solid pieces are in contact with the sealing plates. This can facilitate obtaining a leak free seal between the sealing plate material and the tube passing through it. These solid pieces can also act as electrical connection pieces, where, if used at the ends of the cell tube (650), at one end of a cell tube the end piece is in electrical connection with the outer macroporous electronically conductive layer and at the other end the other end piece is in contact with the inner macroporous electronically conductive layer. Such solid pieces can be similar to, for example, 612 in FIG. 5B.

When assembling the cell tubes into stacks it can be advantageous to incorporate spacers between the cell tubes to prevent them from getting close enough to one another to cause electrical short circuits within the stack. These spacers can take any convenient form, but in general can include electronically insulating materials that can be interposed between adjacent cell tubes in a stack. The spacers can be in the form of rings that are placed over the outside of the cell tubes, a mesh sleeve that is placed over at least one of each pair of adjacent cell tubes, a separate spacer rod inserted between cell tubes, a sealing plate with openings for the cell tubes to pass through with the openings spaced such that adjacent cell tubes are prevented from touching, or other suitable means. The spacers can be made entirely of electronically insulating materials or can have just an outer surface or portion of an outer surface that is electronically insulating. Merely by way of example of a spacer including electronically insulating and electronically conductive materials, the spacer can be a metal tube that is coated on its external surface with an electronically insulating material.

Tubes used as spacers in the stack can also perform a cooling function. In some embodiments, cooling medium can be introduced into the bore of the spacer tube to assist in the removal of excess heat from the stack. In this aspect of the invention cooling medium such as water can be introduced into spacer tubes interspersed within the stack and running parallel to the cell tubes. The fluid can be introduced by any convenient method. An exemplary embodiment of a stack incorporating this aspect of the invention is shown in FIG. 7 in schematic form. Referring to FIG. 7, a cross section longitudinally though a stack 900 is shown. The stack has an outer housing 901. The housing is divided into five main compartments (910, 911, 912, 913 and 914) by sealing plates 904 (first sealing plates) and sealing plates 905 (second sealing plates). The cell tubes 902 are sealed through sealing plates 904. One bar filled with diagonal lines 902 depicts one cell tube. The cooling tubes 903 are sealed through sealing plates 904 and 905. The shell side of the cell tubes are open into compartment 912 (first section), the bore side of the cell tubes open into compartments 911 and 914 (second section), and the bore side of the cooling tubes open into compartments 910 and 913 (third section). Cooling medium is introduced through opening 906 in compartment 910, flows through the cooling tubes picking up any excess heat on the way and enters compartment 913, finally exiting through opening 909 in compartment 913. After exiting through 909 the cooling medium can be allowed to go to waste or be pumped through an external cooling circuit, such as one containing a radiator, before being returned through 906. Gas can be supplied to the bore side of the cell tubes though the opening 907 in compartment 911. If this gas is hydrogen or pure oxygen, it can be entirely converted to water within the stack, so that the opening 908 in compartment 914 can be closed, after optionally being used for flushing the cell tubes, or omitted altogether. If the gas is air or other gas containing components that do not get consumed in the stack, then the unreacted gases can exit though 908 after passing through the bores of the cell tubes. Gas can be supplied to the shell side of the cell tubes 912 through opening 915. Again, if this gas is pure hydrogen or oxygen a second opening 916 for gas to exit is optional and may be needed for initial flushing of the system. If, however, the gas contains components not consumed by the fuel cells, such as nitrogen in air, then the opening 916 can remove the excess gas. Water formed in the stack can be carried out of the stack with the gas exiting 908 and/or 916. In some embodiments, the cooling tubes are not needed to be between each pair of cell tubes. They can be inserted between selected pairs of cell tubes to provide spacing and cooling or just cooling. Spacing between other pairs of cell tubes can be provided by other means as disclosed herein, if required. Merely by way of example, cooling tubes through which cooling medium can be circulated can be placed at intervals throughout the stack to provide cooling and optionally spacing, and rings or sleeves of insulating material can be placed between the pairs of cell tubes between which the cooling tubes are not placed or in addition to the cooling tube to assist in providing spacing.

In some embodiments, cooling tubes can also provide a humidification function. In these embodiments, the cooling tubes have openings in their walls that can allow water vapour to pass but retard the exit of liquid water from the outside wall of the cooling tube. Merely by way of an example, the cooling tubes can be constructed from hydrophobic microporous membrane tubes where the pores in the tube walls are made of a hydrophobic material, or where they are treated to be hydrophobic, to discourage the entry of liquid water into the pores, but allow the passage of water vapour. Tubes with relatively hydrophilic pores such as sintered metal tubes can also be suitable as cooling tubes according to these embodiments. When using cooling tubes with hydrophilic pores the liquid water is capable of penetrating the pores of the cooling tube walls but capillary action can retain it within the pores in the wall, preventing liquid water from flooding the shell side of the stack. As dry gas passes over the outside of the porous cooling tubes the liquid water in the cooling tube can evaporate and humidify the air stream. As the water evaporates it can take in heat, providing cooling for the stack. If hydrophobic membrane tubes are used as the cooling tubes, then porous cooling tubes made of hydrophobic plastics such as teflon, polysulfone, polyvinylidene difluoride, polypropylene, and the like, can be used, where pores have been incorporated into the tube walls by, for example, phase inversion solution casting, mechanical expansion, soluble phase leaching or other methods as are known in the art. Porous cooling tubes constructed of relatively hydrophilic materials such as metals can also be used when they are treated with a hydrophobic surface coating such as a silanization or hydrophobic plastic coating. Porous cooling tubes made of metals or the like can also be used without treatment to make them hydrophobic if the pores in the tube walls are small enough so as to prevent the bulk flow of liquid water exiting the tube walls when in operation. Cooling tubes made of sintered stainless steel can be advantageous as they can be mechanically robust, corrosion resistant, can be made with suitable pore size and are good conductors of heat. It can be desirable to prevent the cooling tubes making unwanted electrical connections between the cell tubes. If the cooling tube material is electrically conductive and it is desired to have the cell tubes in close proximity to the cooling tubes, rings of electronically insulating material can be placed around the cooling tubes or cell tubes, or both, to prevent undesirable short-circuits. It is to be understood that not all of the wall of the cooling tube must allow water to pass but that it can be sufficient for portions of the wall to be porous. For example, the cooling tube can be a composite of two types of tube, where some sections of the composite tube allow the passage of water and others do not. Alternatively, the cooling tube can be fabricated as a solid tube and holes introduced into the tube, for example, by using a laser to burn holes in the tube wall, to form sections of the tube wall that allow water to pass. In another alternative, the cooling tube can be fabricated with a uniformly porous wall and the pores in sections of the wall subsequently blocked, for example, by using a resin that coated or covers the pores and then hardens to block the pores. In some embodiments, rings of resin can be placed around a porous walled cooling tube at intervals where the rings of resin are electronically insulating and act as spacers between the cell tubes, so helping to prevent undesired electrical short-circuits.

In other embodiments the shell side of the stack can be flooded with water and reactant gas bubbles dispersed throughout the liquid in the shell side to supply reactant gas to the cell tubes. The liquid flooding the shells side can collect excess heat and flow out of the stack to remove the heat. An exemplary embodiment of a stack incorporating this aspect of the invention is shown in FIG. 8 in schematic form. Referring to FIG. 8, a cross section longitudinally though a stack 1000 is shown. The stack has an outer housing 1001. The housing is divided into five main compartments (1010, 1011, 1012, 1013 and 1014) by sealing plates 1004 (first sealing plates) and sealing plates 1005 (second sealing plates). The cell tubes 1002 are sealed through sealing plates 1004. One bar filled with diagonal lines 1002 depicts one cell tube. Tubes 1003 (gas tubes) that can allow reactant gas and/or liquid to be introduced into and exit the shell side are sealed through sealing plates 1004 and 1005. The shell side of the cell tubes are open into compartment 1012 (first section), the bore side of the cell tubes open into compartments 1011 and 1014 (second section), and the bore side of the gas tubes open into compartments 1010 and 1013 (third section). Gas and/or liquid can be introduced through opening 1006 in compartment 1010, flow through the gas tubes and enter compartment 1012. Excess gas can exit through opening 1009 in compartment 1013. Liquid can also exit through gas tubes 1003, then through opening 1009 in compartment 1013, and be circulated through an external cooling circuit. Gas can be supplied to the bore side of the cell tubes though the opening 1007 in compartment 1011. If this gas is hydrogen or pure oxygen, it can be entirely converted to water within the stack, so that the opening 1008 in compartment 1014 can be closed, after optionally being used for flushing the cell tubes, or omitted altogether. If the gas is air or other gas containing components that do not get consumed in the stack, then the unreacted gases can exit though 1008 after passing through the bores of the cell tubes. Water formed in the stack can be carried out of the stack with the gas exiting 1008 and/or 1009.

### Application as an Electrolyser

The fuel cell elements (and/or the assembly thereof, and/or the stack) disclosed herein are suitable for use as an electrolyser to split water as well as for a fuel cell. The macroporous electrode structure has high surface area in intimate contact with a catalyst (e.g., platinum) and an ion conductor. When used as an electrolyser, this can enable the structure to support high current densities with low internal electrical losses, thus improving the energy efficiency of water splitting to form hydrogen and oxygen.

Unlike plate-and-frame type fuel cells of the prior art, the tubular structure of the fuel cells disclosed herein can facilitate the removal of the evolved gas from the fuel cell element (and/or an assembly, and/or a stack), reducing or minimising the problem of gas bubbles blocking the structure and degrading its performance when it is used as an electrolyser.

Additionally, as the ion conduction is provided by the PEM, it is acceptable to use relatively pure water in such an electrolyser system. This can reduce or minimise the potential for contamination of the catalyst via the addition of dissolved salts, where the pure water can be generated separately or collected during the fuel cell part of the cycle and stored for use during the electrolysis part of the cycle.

Depending upon the power source available, it can be advantageous to have fewer in-series fuel cell elements and more in-parallel fuel cell elements in an electrolyser stack compared to a fuel cell stack. In some embodiments disclosed herein, this can be achieved by using longer sections for the individual fuel cell elements or by using the same composite cell tubes but connecting more of the composite cell tubes in parallel rather than in series.

To use a stack as an electrolyser, water is brought into contact with the cell tubes (or tubular fuel cell elements) and a voltage applied between the outer and inner conductors of the cell elements sufficient to split the water into hydrogen and oxygen. The gases thus evolved can then be vented to outside the stack through the bore (internal) side of the cell tubes (or tubular fuel cell elements) and the shell (external) side of the cell tubes (or tubular fuel cell elements) and collected and stored separately. In some embodiments, liquid water is introduced to both the shell (external) side and the bore (internal) side of the cell tubes (or tubular fuel cell elements). In these embodiments, it can be preferable for the cell tubes (or tubular fuel cell elements) to be placed vertically to aid venting of gas from the bore (internal) side of the cell tubes (or tubular fuel cell elements). In some embodiments, liquid water is introduced only to the shell side or only to the bore side of the cell tubes.

In some embodiments, water can be introduced to the shell (external) side and/or the bore (internal) side of the cell tubes (or tubular fuel cell elements) as water vapour. This can facilitate the switch over from a stack being used as an electrolyser to a fuel cell and back, as no liquids would need to be drained from or fill the stack, rather just the power supply removed and replaced by an electrical load or vice versa.

### EXAMPLES

The following non-limiting examples are provided to further illustrate embodiments of the invention described herein. It should be appreciated by those of skill in the art that the techniques disclosed in the examples that follow represent approaches discovered by the inventors to function well in the practice of the application, and thus can be considered to constitute examples of modes for its practice. However, those of skill in the art should, in light of the instant disclosure, appreciate that many changes can be made in the specific embodiments that are disclosed and still obtain a like or similar result without departing from the spirit and scope of the application.

### Example 1

A fuel cell element according to one exemplary embodiment of the current invention was fabricated and tested as a fuel cell. An 80-micron-thick sheet of 304 stainless steel was perforated by punching holes through the sheet with a series of pins to leave a pattern of holes. Rows of 0.4 mm diameter round holes were formed with the holes within the row at 1 mm spacing. Adjacent rows were spaced apart by 1.5 mm and the position of the holes in one row was offset from those in the adjacent rows. In this way a rectangular grid of holes 30 mm long by 9.5 mm wide was formed. A piece of this perforated stainless steel sheet that was 50 mm long by 9.5 mm wide was then cut, such that the perforations covered the full width of the piece but the perforations stopped 10 mm short of each end of the piece. A length of electrical connection wire was soldered to the non-perforated section of the stainless steel sheet at one end to act as the inner electrical connection point for the completed fuel cell. The perforated piece was then formed into a tube structure around a 3-mm diameter steel rod and wound such that the crowns of material formed in the process of perforating the stainless steel sheet were on the outside of the tube structure. The seam of the tube structure was tacked together by melting polypropylene over the seam at either end. The polypropylene was melted using a soldering iron and transferred to cover the seam. It was important to ensure that some of the polypropylene penetrated perforations in the sheet to give sufficient strength to the join. In this way, a 50-mm-long tube structure with an internal diameter of 3 mm was formed. This tube structure was to form the inner current collector layer in the completed fuel cell element.

A 10-mm-wide by 100-mm-long strip of EC2019 woven carbon cloth electrode material (Fuel Cell Earth) was taped at one end of the tube structure (over the section where there were no perforations in the inner current collector layer), and the strip wound helically around the tube structure to form a continuous layer down the length of the tube structure where the adjacent winds abutted one another but did not overlap. The strip was taped at the other end of the tube structure to keep it in place. The EC2019 is a woven carbon filament material with 20% by weight platinum supported on carbon particles coated on to one side. The side of the EC2019 coated with platinum was on the outside of the wound layer. This layer formed the inner macroporous electronically conductive layer and the inner electrode layer.

Next, a strip of 50-micron-thick Nafion® membrane NRE-212 (DuPont) 11 mm wide by 100 mm long was taped at one end of the tube structure and helically wound such that there was approximately 1 to 2 mm overlap of the adjacent winds. The NRE-212 strip was then taped at the other end to keep it in place. This formed the PEM layer of the fuel cell element.

Next, a second piece of EC2019 10 mm wide by 100 mm long was wound around the tube structure in a similar manner to the first strip of EC2019 wound. With this piece of EC2019 the catalyst was supported on the inside of the wound strip, so facing the PEM. This layer formed the outer macroporous electronically conductive layer and the outer electrode layer.

Next, a length of 0.5-mm diameter tinned copper wire was wound around the tube structure. At the start of the winding, adjacent turns of wire were soldered to one another to keep the wire from unwinding from that end. The wire was then wound helically around the outside with tension applied so that it was tightly wound and there were approximately 0.5-mm to 1-mm gaps between the turns of wire. When the wrapping reached the far end of the tube structure, the wire was wound so that several adjacent turns abutted each other and solder placed across the adjacent turns at one spot to stop the wire from unwinding when the tension was removed. The wire was then back-wrapped over the top of the primary turns at a shallower angle and tacked with solder at the other end of the tube structure from whence the back-wrapping commenced. This layer formed the outer current collector layer. An extra length of wire was left after the back-wrapping operation to act as an electrical connection to the outer current collector layer.

The now assembled fuel cell element was then removed from the 3 mm diameter steel rod to form a stand-alone fuel cell element. In order to be able to connect the bore of the single fuel cell element to a hydrogen supply, conical polypropylene tube structures were glued to each end of the fuel cell element using epoxy resin and allowed to dry. The wire that had previously been soldered to the inner surface of the stainless steel sheet was brought out through the bore of one of the conical polypropylene tube structures.

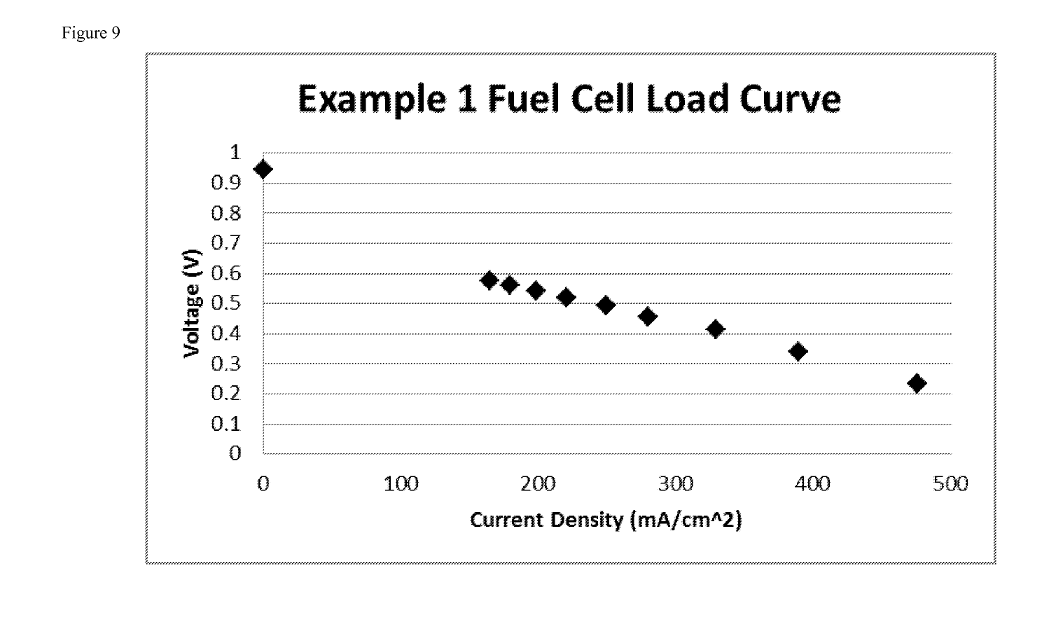

The fuel cell element was tested in the following manner. The fuel cell element was left suspended over water in a closed container at room temperature to let the Nafion® absorb water in a high humidity environment to initially condition it for use. The fuel cell element was then removed from the container and the inner and outer current collector connection wires joined to a connection block. Hydrogen gas supplied from a cylinder was bubbled though water to humidify it somewhat and then supplied to the bore side of the fuel cell element via a tube structure connected to the small end of the conical polypropylene tube structure that did not have the inner connection wire running through it. Excess hydrogen gas was allowed to exit the fuel cell element via a second tube structure connected to the other end of the fuel cell element. Room air surrounding the fuel cell element was used as the source of oxygen. A multimeter was placed across the connection wires to measure the voltage between the inner and outer current collectors and hydrogen supplied to the bore of the cell. Various load resistors from 0.13 Ohms to 0.92 Ohms were placed between the connection wires and the voltage measured. The open circuit voltage was also measured with no load resistor in place. The current flowing through the circuit was inferred from the voltage difference measured across the load resistor and the known resistance of the resistor. The area of the fuel cell was estimated by using the circumference of the PEM layer of 4 mm and the length of the perforated area of the inner current collector of 30 mm. This gave an area of 3.8 cm². The calculated currents were divided by the area to give a current density in milliamps per cm². FIG. 9 shows a plot of the voltage measured across the load resistor versus the density of current flowing.

### Example 2

A fuel cell element according to a second exemplary embodiment of the current invention was fabricated and tested as a fuel cell. A 30-mm-long section of a 12-mm outer diameter macroporous sintered stainless steel tube structure with a 1-mm wall thickness was taken as the inner current collector for the fuel cell element.

A 10-mm-wide by 100-mm-long strip of EC2019 woven carbon cloth electrode material (Fuel Cell Earth) was taped at one end of the tube structure and the strip wound helically around the tube structure to form a continuous layer down the length of the tube structure, where the adjacent winds abutted one another but did no overlap. The strip was taped at the other end of the tube structure to keep it in place. The EC2019 is a woven carbon filament material with 20% by weight platinum supported on carbon particles coated on to one side. The side of the EC2019 coated was on the outside of the wound layer. This layer formed the inner macroporous electronically conductive layer and the inner electrode layer.

Next, a strip of 50-micron-thick Nafion® membrane NRE-212 (DuPont) 40 mm wide by 30 mm long was wrapped around the carbon cloth layer such that it was overlapped by 1 to 2 mm at a straight seam down the length of the tube structure. The wrapped Nafion® was taped at either end to hold it in place with a 12-mm-long section of Nafion® exposed to the EC2019 between the taped ends. This formed the PEM layer of the fuel cell element.

Next, a second piece of EC2019 10 mm wide by 100 mm long was wound around the tube structure in a similar manner to the first strip of EC2019 wound. With this piece of EC2019 the catalyst was supported on the inside of the wound strip, so facing the PEM. This layer formed the outer macroporous electronically conductive layer and the outer electrode layer.

Next, a length of 0.5 mm diameter tinned copper wire was wound around the tube structure. At the start of the winding the wire was twisted together to form a tight loop of wire over the tape at one end of the tube structure. The wire was then wound helically around the outside with 2 kg of tension applied so that it was tightly wound and there were approximately 0 to 0.5-mm gaps between the turns of wire. When the wrapping reached the far end of the tube structure the wire was back-wrapped over the top of the primary turns at a shallower angle and at the other end of the tube structure from whence the back-wrapping commenced, twisted together with a length of wire that was left long from the start of the primary wrapping. This layer formed the outer current collector layer. An extra length of this wire was left after the back-wrapping operation to act as an electrical connection to the outer current collector layer.

Aluminium tube structures whose outer diameter was a slide fit into the bore of the sintered stainless steel tube structure were inserted into the ends of the sintered stainless steel tube structure and glued with epoxy adhesive. The adhesive was also placed so as to close off the macropores at the ends of the sintered tube structure to minimise gas leakage out of the end of the tube structure. Tinned copper wire was wound around one of the aluminium end pieces and twisted around itself to tighten it. A length of wire was left to act as an electrical connection to the inner current collector.

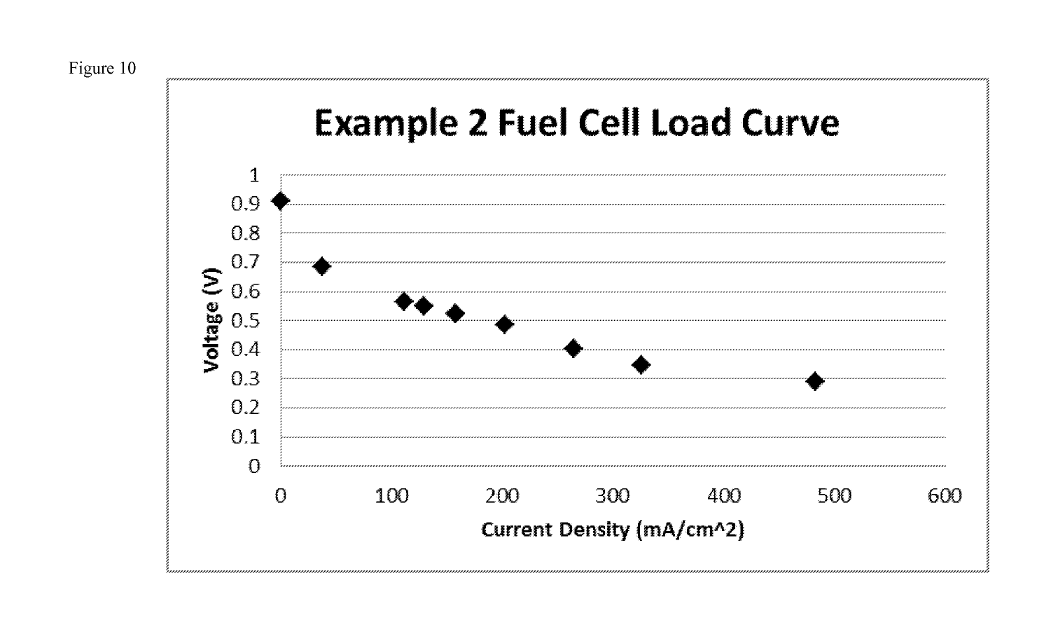

The fuel cell element was tested in the following manner. The fuel cell element was left suspended over water in a closed container at room temperature to let the Nafion® absorb water in a high humidity environment to initially condition it for use. The fuel cell element was then removed from the container and the inner and outer current collector connection wires joined to a connection block. Hydrogen gas supplied from a cylinder was bubbled though water to humidify it somewhat and then supplied to the bore side of the fuel cell element via a tube structure connected to the small end of the conical polypropylene tube structure that did not have the inner connection wire running through it. Excess hydrogen gas was allowed to exit the fuel cell element via a second tube structure connected to the other end of the fuel cell element. Room air surrounding the fuel cell element was used as the source of oxygen. A multimeter was placed across the connection wires to measure the voltage between the inner and outer current collectors and hydrogen supplied to the bore of the cell. Various load resistors from 0.13 Ohms to 4 Ohms were placed between the connection wires and the voltage measured. The open circuit voltage was also measured with no load resistor in place. The current flowing through the circuit was inferred from the voltage difference measured across the load resistor and the known resistance of the resistor. The area of the fuel cell was estimated by using the circumference of the PEM layer of 12.2 mm and the length of the accessible PEM area of 12 mm. This gave an area of 4.6 cm². The calculated currents were divided by the area to give a current density in milliamps per cm². FIG. 10 shows a plot of the voltage measured across the load resistor versus the density of current flowing.

As will be appreciated by one skilled in the art the elements and structures disclosed here could be used in many combinations and appreciate that these form part of the current invention.

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the numbers expressing quantities of ingredients, properties such as molecular weight, reaction conditions, and so forth, used to describe and claim certain embodiments of the application are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Preferred embodiments of this application are described herein, including the best mode known to the inventors for carrying out the application. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the instant document, or any of same that may have a limiting affect as to the broadest scope of the claims now or later associated with the instant document. By way of example, should there be any inconsistency or conflict between the description, definition, and/or the use of a term associated with any of the incorporated material and that associated with the instant document, the description, definition, and/or the use of the term in the instant document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the invention disclosed herein are not limited to that precisely as shown and described.

1. A tubular cell element comprising an inner electronically conductive layer, an outer electronically conductive layer, and an ion conductive layer, wherein at least one of the inner electronically conductive layer, the outer electronically conductive layer and the ion conductive layer comprises a sheet of material wrapped to form a tube structure.

2. The tubular cell element of claim 1 further comprising an inner current collector layer and an outer current collector layer, wherein at least one of the inner current collector layer and the outer current collector layer comprises a sheet of material wrapped to form a tube structure.

3. (canceled)

4. The tubular cell element of claim 1, wherein at least one of the inner electronically conductive layer, the outer electronically conductive layer, and the ion conductive layer is helically wound.

5. The tubular cell element of claim 2, wherein at least one of the inner current collector layers and the outer current collector layer comprises an incomplete layer of solid non-porous material, wherein the incomplete layer comprises a wire or a perforated sheet material.

6. (canceled)

7. (canceled)

8. The tubular cell element of claim 1, wherein at least one of the inner electronically conductive layer and the outer electronically conductive layer comprises at least one material selected from a carbon filament material, or a particulate material selected from the group consisting of carbon, stainless steel, titanium, nickel, copper, tin, and an alloy thereof.

9.-17. (canceled)

18. The tubular cell element of claim 1, wherein the ion conductive layer is formed by winding a sheet of ion conductive material around a tube structure comprising the inner electronically conductive layer, wherein the adjacent winds of the ion conductive sheet are placed so as to at least partially overlap to form an overlap region.

19. The tubular cell element of claim 1 comprising a catalyst in contact with the ion conductive layer.

20. (canceled)

21. (canceled)

22. The tubular cell element of claim 19, wherein the catalyst comprises platinum or ruthenium.

23. (canceled)

24. (canceled)

25. A cell tube comprising a multiplicity of tubular cell elements of claim 1, wherein the tubular cell elements are assembled end to end in electrical connection, wherein the assembly of the multiplicity of tubular cell elements forms a tubular structure with a shell side and a bore side, wherein a first agent on the shell side of the cell tube can be substantially prevented from mixing with a second agent on the bore side of the cell tube.

26. (canceled)

27. (canceled)

28. The cell tube of claim 25, wherein the electrical connection comprises at least one connection selected from an in-serial connection and an in-parallel connection.

29. (canceled)

30. (canceled)

31. The cell tube of claim 25, wherein the electrical connection comprises an electronically conductive connecting piece, wherein the cell tube further comprises at least one electronically insulating sealing piece, wherein the at least one electronically insulating sealing piece comprises at least two faces, wherein one face forms a seal with the electronically conductive connecting piece, wherein the other face forms a seal with the ion conductive layer of the tubular cell element.

32. A stack comprising a plurality of the cell tubes of claim 25, wherein the ends of the plurality of the cell tubes are sealed into at least a first sealing plate, wherein the first sealing plate divides the stack into at least a first section and a second section, wherein the shell side of the cell tubes are open to the first section, wherein the bore side of the cell tubes are open to the second section.

33. (canceled)

34. (canceled)

35. The stack of claim 32 further comprising one or more cooling tubes, wherein the ends of the one or more cooling tubes are sealed into at least a second sealing plate, wherein the first sealing plate and the second sealing plate divide the stack into the first section, the second section, and a third section, wherein the bore side of the cooling tubes are open to the third section.

36.-42. (canceled)

43. A method of manufacturing a tubular cell element of claim 1 comprising
forming a tube structure using a first electronically conductive material to form an inner electronically conductive layer;
wrapping a sheet of ion conductive material around the tube structure comprising the inner electronically conductive layer; and
wrapping a second electronically conductive material to form an outer electronically conductive layer.

44. (canceled)

45. A method of manufacturing a cell tube of claim 25.

46. A method of manufacturing a stack of claim 32.

47. A method of using a stack of claim 32 comprising
providing a first agent to the first section, wherein the first agent is brought into contact with the shell side of the cell tubes; and
providing a second agent to the second section, wherein the second agent is brought into contact with the bore side of the cell tubes.

48. (canceled)

49. The method of claim 47 comprising removing heat from the stack, wherein the removing the heat comprises introducing a fine spray of droplets of a cooling medium into at least one of the first agent or the second agent before entering the stack or contacting the cell tubes.

50.-53. (canceled)

54. A method of using the tubular cell elements of claim 1 wherein the tubular cell elements can be used either as a fuel cell or an electrolyser.

55. The method of claim 54 wherein a multiplicity of tubular cell elements are assembled into a device that can be used to produce electricity by feeding the device reactant gases or can be used electrolyse water to produce reactant gases.

56. A method of manufacturing a tubular cell element of claim 2 comprising
forming a tube structure using a current collector material to form an inner current collector;
wrapping a sheet of electronically conductive material around the tube structure to form an inner electronically conductive layer;
wrapping a sheet of ion conductive material around the inner electronically conductive layer to form an ion conductive layer; and
wrapping a second sheet of electronically conductive material around the ion conductive layer to form an outer electronically conductive layer.

57. The method of claim 56 further comprising wrapping a current collector material around the outer electronically conductive layer to form an outer current collector.
